(19) United States
(12) Patent Application Publication
(10) Pub. No.: US 2025/0377494 A1
(43) Pub. Date: Dec. 11, 2025

(54) LIQUID CRYSTAL POLARIZATION INTERFERENCE ELEMENT AND FILTER

(71) Applicant: FUJIFILM Corporation, Tokyo (JP)

(72) Inventors: Yukito SAITOH, Minamiashigara-shi (JP); Yujiro YANAI, Minamiashigara-shi (JP); Kazuya HISANAGA, Minamiashigara-shi (JP)

(73) Assignee: FUJIFILM Corporation, Tokyo (JP)

(21) Appl. No.: 19/310,984

(22) Filed: Aug. 27, 2025

Related U.S. Application Data
(63) Continuation of application No. PCT/JP2024/008812, filed on Mar. 7, 2024.

(30) Foreign Application Priority Data
Mar. 8, 2023 (JP) 2023-035595
Jan. 26, 2024 (JP) 2024-010181

(51) Int. Cl. G02B 5/28; G02B 5/30

(52) U.S. Cl. CPC G02B 5/28; G02B 5/3016

(57) ABSTRACT

A liquid crystal polarization interference element includes two or more layer sets, each set comprising a first and second liquid crystal layer. The first liquid crystal layer includes a horizontally aligned layer formed by immobilizing horizontally aligned liquid crystal compounds and a vertically aligned layer formed by immobilizing vertically aligned liquid crystal compounds. The second liquid crystal layer includes a horizontally aligned layer formed by immobilizing a horizontally aligned liquid crystal compound and a vertically aligned layer formed by immobilizing a vertically aligned liquid crystal compound. The liquid crystal compounds are rod-like or disk-like. The in-plane slow axes of the first and second liquid crystal layers intersect. The in-plane retardation of the horizontally aligned layer is 1.33 to 4 times the thickness-direction retardation of the vertically aligned layer, and the in-plane retardations of the first and second liquid crystal layers are equal.

### CROSS-REFERENCE TO RELATED APPLICATIONS

This application is a Continuation of PCT International Application No. PCT/JP2024/008812 filed on Mar. 7, 2024, which claims priority under 35 U.S.C. § 119 (a) to Japanese Patent Application No. 2023-035595 filed on Mar. 8, 2023 and Japanese Patent Application No. 2024-010181 filed on Jan. 26, 2024. The above applications are hereby expressly incorporated by reference, in their entirety, into the present application.

### BACKGROUND OF THE INVENTION

### 1. Field of the Invention

The present invention relates to a liquid crystal polarization interference element and a filter using the same.

### 2. Description of the Related Art

A band-pass filter that transmits light in a specific wavelength range and shields light in other wavelength ranges is used in various optical devices.

As the band-pass filter, a polarization interference filter using a dielectric multi-layer film, a filter having a polarizer and a birefringent crystal in combination, and the like are known.

In addition, a band-pass filter is also known, in which a birefringent plate (λ/2 plate) in which an angle formed between a direction of a transmission axis of a polarizer and a slow axis is +ρ, and a birefringent plate in which the angle is −ρ, the both plates having the same thickness, are alternately laminated between polarizers arranged in a crossed nicols state, as described in JP2004-101577A.

JP2004-101577A proposes, as an optical filter (band-pass filter) having a small number of components, an optical filter consisting of crystals and having a structure where two types of polarization regions having different crystals are periodically arranged, in which the two different types of polarization regions are different in the principal axis of a refractive index ellipsoid cut parallel to an interface between the two different types of polarization regions.

### SUMMARY OF THE INVENTION

In such a band-pass filter, there is a problem in that a so-called short-wavelength shift occurs, in which the wavelength at which the maximum transmittance is exhibited differs between light incident from the front (vertical direction) and light incident from an oblique direction.

An object of the present invention is to solve such a problem of the related art and to provide a liquid crystal polarization interference element in which a shift in wavelength of a maximum transmittance is unlikely to occur even upon incidence of light from an oblique direction in a case where the liquid crystal polarization interference element is used in a band-pass filter and the like.

In order to accomplish the object, the present invention has the following configurations.
[1] A liquid crystal polarization interference element including:
two or more liquid crystal layer sets in a thickness direction, each set consisting of a first liquid crystal layer and a second liquid crystal layer, in which the first liquid crystal layer includes at least one first horizontally aligned liquid crystal layer formed by immobilizing first-1 liquid crystal compounds having optical axes aligned horizontally, and at least one first vertically aligned liquid crystal layer formed by immobilizing first-2 liquid crystal compounds having optical axes aligned vertically,
the second liquid crystal layer includes at least one second horizontally aligned liquid crystal layer formed by immobilizing second-1 liquid crystal compounds having optical axes aligned horizontally, and at least one second vertically aligned liquid crystal layer formed by immobilizing second-2 liquid crystal compounds having optical axes aligned vertically,
any of the first-1 liquid crystal compounds and the first-2 liquid crystal compounds are rod-like liquid crystal compounds or disk-like liquid crystal compounds,
any of the second-1 liquid crystal compounds and the second-2 liquid crystal compounds are rod-like liquid crystal compounds or disk-like liquid crystal compounds,
an in-plane slow axis of the first liquid crystal layer and an in-plane slow axis of the second liquid crystal layer intersect with each other,
a sum of in-plane retardations of the first horizontally aligned liquid crystal layer is 1.33 to 4 times a sum of thickness-direction retardations of the first vertically aligned liquid crystal layer,
a sum of in-plane retardations of the second horizontally aligned liquid crystal layer is 1.33 to 4 times a sum of thickness-direction retardations of the second vertically aligned liquid crystal layer, and
an in-plane retardation of the first liquid crystal layer and an in-plane retardation of the second liquid crystal layer are equal to each other.
[2] The liquid crystal polarization interference element according to [1],
in which the sum of the in-plane retardations of the first horizontally aligned liquid crystal layer is 2 times the sum of the thickness-direction retardations of the first vertically aligned liquid crystal layer, and
the sum of the in-plane retardations of the second horizontally aligned liquid crystal layer is 2 times the sum of the thickness-direction retardations of the second vertically aligned liquid crystal layer.
[3] The liquid crystal polarization interference element according to [1] or [2],
in which the liquid crystal polarization interference element has three or more liquid crystal layer sets in the thickness direction, and
the angles formed between the in-plane slow axis of the first liquid crystal layer and the in-plane slow axis of the second liquid crystal layer, and in-plane retardations of the first liquid crystal layer and the second liquid crystal layer differ between the liquid crystal layer sets arranged on both sides in the thickness direction and the liquid crystal layer set arranged in a central part in the thickness direction.
[4] The liquid crystal polarization interference element according to any one of [1] to [3],
in which the first liquid crystal layer and the second liquid crystal layer include an infrared absorbing colorant.
[5] The liquid crystal polarization interference element according to any one of [1] to [4],
in which the first liquid crystal layer and the second liquid crystal layer include a liquid crystal elastomer.
[6] A filter including:
the liquid crystal polarization interference element according to any one of [1] to [5]; and
two polarizers that sandwich the liquid crystal polarization interference element in a thickness direction,
in which the two polarizers are arranged such that transmission axes of the two polarizers are orthogonal to each other.
[7] The filter according to [6], further including:
a retardation layer between one or both of the two polarizers and the liquid crystal layer set,
in which an in-plane slow axis of the retardation layer is parallel to an absorption axis of either of both the polarizers.

According to the present invention, it is possible to provide a liquid crystal polarization interference element in which a shift in wavelength of maximum transmittance is unlikely to occur even upon incidence of light from an oblique direction in a case where the liquid crystal polarization interference element is used in a band-pass filter and the like.

### BRIEF DESCRIPTION OF THE DRAWINGS

FIG. 1 is a view conceptually showing an example of a filter having a liquid crystal polarization interference element of an embodiment of the present invention.

FIG. 2 is a graph for describing a filter having the liquid crystal polarization interference element of the embodiment of the present invention.

FIG. 3 is a graph for describing a filter having the liquid crystal polarization interference element of the embodiment of the present invention.

FIG. 4 is a view conceptually showing a filter having a liquid crystal polarization interference element in another example of the present invention.

### DESCRIPTION OF THE PREFERRED EMBODIMENTS

Hereinafter, a liquid crystal polarization interference element and a filter of embodiments of the present invention will be described in detail based on suitable Examples shown in the accompanying drawings.

In the present specification, numerical ranges represented by “to” include numerical values before and after “to” as lower limit values and upper limit values.

In the present specification, for example, angles such as “45°”, “parallel”, “perpendicular” or “orthogonal” mean that a difference from an exact angle is within a range of less than 5 degrees unless otherwise noted. The difference from the exact angle is preferably less than 3 degrees, and more preferably less than 1 degree.

In the present specification, the meaning of the term “the same”, “equal”, or the like includes a case where an error range is generally allowable in the technical field.

In the present specification, Re(λ) represents an in-plane retardation at a wavelength of λ.

In the present specification, Re(λ) is a value measured at the wavelength of λ using AxoScan (manufactured by Axometrics, Inc.). By inputting an average refractive index ((nx+ny+nz)/3) and a film thickness (d(μm)) to AxoScan, the following expression can be calculated.

$$Slow axis direction ( ° )$$

$$Re ( λ ) = R 0 ( λ )$$

Furthermore, R0(λ) is displayed as a numerical value calculated by AxoScan, but means Re(λ).

In addition, all of the drawings shown below are conceptual views for describing the present invention, and the positional relationship, size, thickness, shape, and the like of each constituent element are different from the actual ones.

### [Liquid Crystal Polarization Interference Element and Filter]

The liquid crystal polarization interference element of the embodiment of the present invention is a liquid crystal polarization interference element including:
two or more liquid crystal layer sets in a thickness direction, each set consisting of a first liquid crystal layer and a second liquid crystal layer,
in which the first liquid crystal layer includes at least one first horizontally aligned liquid crystal layer formed by immobilizing first-1 liquid crystal compounds having optical axes aligned horizontally, and at least one first vertically aligned liquid crystal layer formed by immobilizing first-2 liquid crystal compounds having optical axes aligned vertically,
the second liquid crystal layer includes at least one second horizontally aligned liquid crystal layer formed by immobilizing second-1 liquid crystal compounds having optical axes aligned horizontally, and at least one second vertically aligned liquid crystal layer formed by immobilizing second-2 liquid crystal compounds having optical axes aligned vertically,
any of the first-1 liquid crystal compounds and the first-2 liquid crystal compounds are rod-like liquid crystal compounds or disk-like liquid crystal compounds,
any of the second-1 liquid crystal compounds and the second-2 liquid crystal compounds are rod-like liquid crystal compounds or disk-like liquid crystal compounds,
an in-plane slow axis of the first liquid crystal layer and an in-plane slow axis of the second liquid crystal layer intersect with each other,
a sum of in-plane retardations of the first horizontally aligned liquid crystal layer is 1.33 to 4 times a sum of thickness-direction retardations of the first vertically aligned liquid crystal layer,
a sum of in-plane retardations of the second horizontally aligned liquid crystal layer is 1.33 to 4 times a sum of thickness-direction retardations of the second vertically aligned liquid crystal layer, and
an in-plane retardation of the first liquid crystal layer and an in-plane retardation of the second liquid crystal layer are equal to each other.

In addition, the filter of the embodiment of the present invention is a filter including:
the liquid crystal polarization interference element, and
two polarizers that sandwich the liquid crystal polarization interference element in a thickness direction, and
the two polarizers are arranged such that transmission axes thereof are orthogonal to each other.

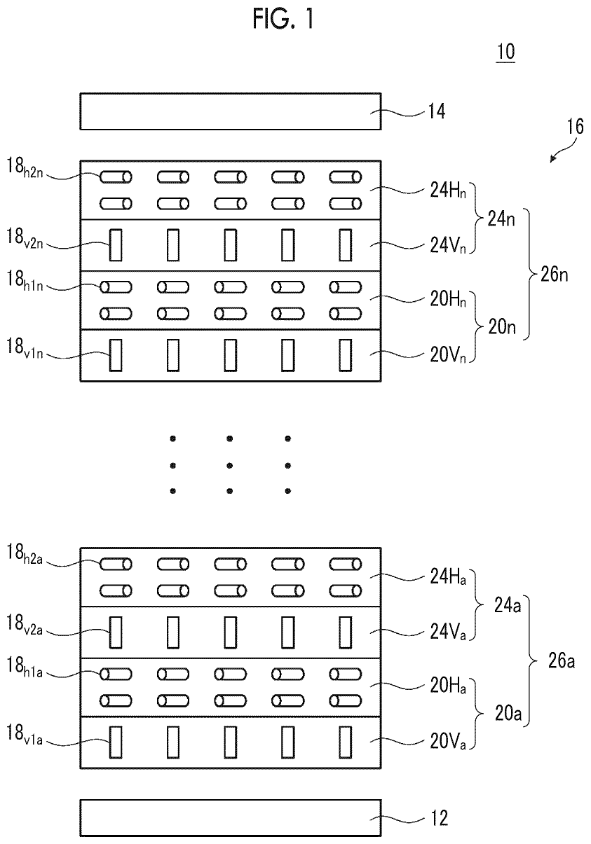

An example of the filter of the embodiment of the present invention, the filter having the liquid crystal polarization interference element of the embodiment of the present invention, is conceptually shown in FIG. 1.

A filter 10 shown in FIG. 1 is a band-pass filter (narrowband filter) that transmits light in a specific wavelength range and shields light in the other wavelength range. The filter 10 includes a first polarizer 12, a second polarizer 14, and a liquid crystal polarization interference element 16. The liquid crystal polarization interference element 16 is arranged between the first polarizer 12 and the second polarizer 14.

The first polarizer 12 and the second polarizer 14 are polarizers (polarizing plates) that transmit linearly polarized light in a predetermined direction, and are arranged in a crossed nicols state with transmission axes being orthogonal to each other.

The first polarizer 12 and the second polarizer 14 are not limited and various known linear polarizers such as an iodine-based polarizer, a dye-based polarizer using a dichroic dye, a polyene-based polarizer, and a wire grid polarizer can be used.

In the filter 10 in the example shown in the drawing, the liquid crystal polarization interference element 16 is arranged between the first polarizer 12 and the second polarizer 14.

Furthermore, the first polarizer 12 and the second polarizer 14 are spaced from the liquid crystal polarization interference element 16 in FIG. 1.

However, the present invention is not limited thereto, and the first polarizer 12, the second polarizer 14, and the liquid crystal polarization interference element 16 may be laminated in contact with each other. In addition, in a case where the first polarizer 12 and the second polarizer 14 are in contact with the liquid crystal polarization interference element 16, they may be adhered to each other with an adhesive which is transparent to transmitted light, such as an optical clear adhesive (OCA) and an acrylic pressure sensitive adhesive, as necessary.

The liquid crystal polarization interference element 16 is an optical element that acts as a λ/2 retardation plate for light in a specific wavelength range (specific wavelength) and does not act as a retardation layer for light in other wavelength ranges.

As described above, the first polarizer 12 and the second polarizer 14 are polarizers that are arranged in a crossed nicols state with transmission axes being orthogonal to each other.

Accordingly, with regard to the light incident onto the filter 10, only linearly polarized light in a predetermined direction is transmitted through the first polarizer 12. In the linearly polarized light, the polarization direction of light having a specific wavelength is rotated by 90° by the liquid crystal polarization interference element 16, and the light having a specific wavelength enters and transmits through the second polarizer 14 arranged in a crossed nicols state with respect to the first polarizer 12. In contrast, the liquid crystal polarization interference element 16 does not act as a retardation layer for light in a wavelength range other than the specific wavelength range. Accordingly, the light is incident onto the second polarizer 14 arranged in a crossed nicols state with respect to the first polarizer 12, and is shielded.

With such an optical action, the filter 10 functions as a band-pass filter that transmits only light in a specific wavelength range and shields other light.

The liquid crystal polarization interference element 16 is formed by laminating an even number of the liquid crystal layers each formed by immobilizing liquid crystal compounds aligned in a predetermined direction.

Specifically, the liquid crystal polarization interference element 16 is obtained by laminating two or more liquid crystal layer sets 26, each consisting of the first liquid crystal layer 20 and the second liquid crystal layer 24 in the thickness direction.

Accordingly, the total number of the first liquid crystal layers 20 and the second liquid crystal layers 24 laminated is an even number.

In the example shown in FIG. 1, the liquid crystal polarization interference element 16 has the first to n-th liquid crystal layer sets.

In the one liquid crystal layer set 26, the first liquid crystal layer 20 and the second liquid crystal layer 24 each include at least one horizontally aligned liquid crystal layer formed by immobilizing liquid crystal compounds having optical axes horizontally aligned and at least one vertically aligned liquid crystal layer formed by immobilizing liquid crystal compounds having optical axes vertically aligned.

In the following description, the liquid crystal layer set closest to the first polarizer 12 side will be defined as a first liquid crystal layer set 26a, the liquid crystal layer set closest to the second polarizer 14 side will be defined as an n-th liquid crystal layer set 26n, and in a case where it is not necessary to distinguish the liquid crystal layer sets from each other, the liquid crystal layer sets will also be referred to as the liquid crystal layer set 26. In addition, the first liquid crystal layer included in the first liquid crystal layer set 26a will be represented by a reference numeral 20a, the second liquid crystal layer will be represented by a reference numeral 24a, the first liquid crystal layer included in the n-th liquid crystal layer set 26n will be represented by a reference numeral 20n, and the second liquid crystal layer will be represented by a reference numeral 24n. In a case where it is not necessary to distinguish the first liquid crystal layers from each other, the first liquid crystal layers will also be referred to as the first liquid crystal layer 20, and in a case where it is not necessary to distinguish the second liquid crystal layers from each other, the second liquid crystal layers will also be referred to as the second liquid crystal layer 24. Moreover, the horizontally aligned liquid crystal layer included in the first liquid crystal layer 20a of the first liquid crystal layer set 26a will be defined as a first horizontally aligned liquid crystal layer 20Ha, the horizontally aligned liquid crystal layer in the first liquid crystal layer 20n of the n-th liquid crystal layer set 26n will be defined as a first horizontally aligned liquid crystal layer 20Hn, and in a case where it is not necessary to distinguish the first horizontally aligned liquid crystal layers from each other, the first horizontally aligned liquid crystal layers will also be referred to as a first horizontally aligned liquid crystal layer 20H. In addition, the vertically aligned liquid crystal layer included in the first liquid crystal layer 20a of the first liquid crystal layer set 26a is referred to as a first vertically aligned liquid crystal layer 20Va, the vertically aligned liquid crystal layer included in the first liquid crystal layer 20n of the n-th liquid crystal layer set 26n is referred to as a first vertically aligned liquid crystal layer 20Vn, and in a case where it is not necessary to distinguish the first vertically aligned liquid crystal layers from each other, the first vertically aligned liquid crystal layers are also referred to as a first vertically aligned liquid crystal layer 20V. Moreover, the horizontally aligned liquid crystal layer included in the second liquid crystal layer 24a of the first liquid crystal layer set 26a will also be defined as a second horizontally aligned liquid crystal layer 24Ha, the horizontally aligned liquid crystal layer included in the second liquid crystal layer 24n of the n-th liquid crystal layer set 26n will also be defined as a second horizontally aligned liquid crystal layer 24Hn, and in a case where it is not necessary to distinguish the first horizontally aligned liquid crystal layers from each other, the second horizontally aligned liquid crystal layers will also be referred to as a second horizontally aligned liquid crystal layer 24H. In addition, the vertically aligned liquid crystal layer included in the second liquid crystal layer 24a of the first liquid crystal layer set 26a will also be referred to as a second vertically aligned liquid crystal layer 24Va, the vertically aligned liquid crystal layer included in the second liquid crystal layer 24n of the n-th liquid crystal layer set 26n will also be defined as a second vertically aligned liquid crystal layer 24Vn, and in a case where it is not necessary to distinguish the second vertically aligned liquid crystal layers from each other, the second vertically aligned liquid crystal layers will also be referred to as a first vertically aligned liquid crystal layer 20V.

Hereinafter, the first liquid crystal layer 20a and the second liquid crystal layer 24a of the first liquid crystal layer set 26a will be described as representatives, but basically, the first liquid crystal layer 20 and the second liquid crystal layer 24 of each liquid crystal layer set 26 have the same configuration.

As shown in FIG. 1, the first horizontally aligned liquid crystal layer 20Ha of the first liquid crystal layer 20a is a liquid crystal layer formed by immobilizing the first-1 rod-like liquid crystal compounds 18ₕ₁ₐ such that optical axes thereof are horizontally aligned. The optical axis of the rod-like liquid crystal compound is the major axis direction. That is, the first horizontally aligned liquid crystal layer 20Ha is a layer in which the first-1 rod-like liquid crystal compounds 18ₕ₁ₐ are aligned such that major axis directions thereof are parallel to the main surface of the first horizontally aligned liquid crystal layer 20Ha. In addition, as shown in FIG. 1, in the first horizontally aligned liquid crystal layer 20Ha, each of the first-1 rod-like liquid crystal compounds 18ₕ₁ₐ is aligned such that an optical axis thereof is aligned in one predetermined direction. That is, the first horizontally aligned liquid crystal layer 20Ha is a so-called (positive) A-plate.

Furthermore, the main surface is the maximum surface of a sheet-like material (each layer).

The first vertically aligned liquid crystal layer 20Va of the first liquid crystal layer 20a is a liquid crystal layer formed by immobilizing the first-2 rod-like liquid crystal compounds 18ᵥ₁ₐ such that optical axes thereof are vertically aligned. That is, the first vertically aligned liquid crystal layer 20Va is a layer in which the first-2 rod-like liquid crystal compounds 18ᵥ₁ₐ are aligned such that major axis directions thereof are perpendicular to the main surface of the first vertically aligned liquid crystal layer 20Va. That is, the first vertically aligned liquid crystal layer 20Va is a so-called (positive) C-plate.

In the present invention, the absolute value of a sum of the in-plane retardations of the first horizontally aligned liquid crystal layer 20Ha is about 2 times the absolute value of a sum of the thickness-direction retardations of the first vertically aligned liquid crystal layer 20Va.

This point will be described below.

Similarly, as shown in FIG. 1, the second horizontally aligned liquid crystal layer 24Ha of the second liquid crystal layer 24a is a liquid crystal layer formed by immobilizing the second-1 rod-like liquid crystal compounds 18ₕ₂ₐ such that optical axes thereof are horizontally aligned. That is, the second horizontally aligned liquid crystal layer 24Ha is a layer in which the second-1 rod-like liquid crystal compounds 18ₕ₂ₐ are aligned such that major axis directions thereof are parallel to the main surface of the second horizontally aligned liquid crystal layer 24Ha. In addition, as shown in FIG. 1, in the second horizontally aligned liquid crystal layer 24Ha, each of the second-1 rod-like liquid crystal compounds 18ₕ₂ₐ is aligned such that an optical axis thereof is aligned in one predetermined direction. That is, the second horizontally aligned liquid crystal layer 24Ha is a so-called (positive) A-plate. Furthermore, in the following description, in a case where it is not necessary to distinguish the rod-like liquid crystal compounds constituting each liquid crystal layer from each other, the rod-like liquid crystal compounds are also referred to as a rod-like liquid crystal compound 18.

The second vertically aligned liquid crystal layer 24Va of the second liquid crystal layer 24a is a liquid crystal layer formed by immobilizing the second-2 rod-like liquid crystal compounds 18ᵥ₂ₐ such that optical axes thereof are vertically aligned. That is, the second vertically aligned liquid crystal layer 24Va is a layer in which the second-2 rod-like liquid crystal compounds 18ᵥ₂ₐ are aligned such that major axis directions thereof are perpendicular to the main surface of the second vertically aligned liquid crystal layer 24Va. That is, the second vertically aligned liquid crystal layer 24Va is a so-called (positive)C-plate.

In the present invention, the absolute value of a sum of the in-plane retardations of the second horizontally aligned liquid crystal layer 24Ha is about 2 times the absolute value of a sum of the thickness-direction retardations of the second vertically aligned liquid crystal layer 24Va.

This point will be described below.

In the first liquid crystal layer set 26a, the in-plane slow axis of the first liquid crystal layer 20a and the in-plane slow axis of the second liquid crystal layer 24a intersect with each other.

The direction of the in-plane slow axis of the first liquid crystal layer 20a is mainly due to the alignment direction of the first-1 rod-like liquid crystal compounds 18ₕ₁ₐ in the first horizontally aligned liquid crystal layer 20Ha. Similarly, the in-plane slow axis direction of the second liquid crystal layer 24a is mainly due to the alignment direction of the second-1 rod-like liquid crystal compounds 18ₕ₂ₐ in the second horizontally aligned liquid crystal layer 24Ha.

Accordingly, as shown in FIG. 1, the first liquid crystal layer 20a and the second liquid crystal layer 24a are laminated such that the alignment direction (the direction of the long axis) of the first-1 rod-like liquid crystal compounds 18ₕ₁ₐ in the first horizontally aligned liquid crystal layer 20Ha and the alignment direction (the direction of the long axis) of the second-1 rod-like liquid crystal compounds 18ₕ₂ₐ in the second horizontally aligned liquid crystal layer 24Ha intersect with each other.

In addition, in the first liquid crystal layer set 26a, the in-plane retardation of the first liquid crystal layer 20a and the in-plane retardation of the second liquid crystal layer 24a are substantially equal to each other.

In such a first liquid crystal layer set 26a, a bisector of an angle formed between the slow axis direction of the first liquid crystal layer 20a and the slow axis direction of the second liquid crystal layer 24a is arranged to be parallel to the transmission axis or absorption axis of one of the polarizers (the first polarizer 12 and the second polarizer 14) arranged in a crossed nicols state. That is, in a case where the transmission axis or the absorption axis of one of the polarizers (the first polarizer 12 and the second polarizer 14) is defined as a reference line, and for example, in a case where a clockwise angle is denoted by a plus and a counterclockwise angle is denoted by a minus in a view from the first polarizer 12 side, the angle of the slow axis of the first liquid crystal layer 20a and the angle of the slow axis of the second liquid crystal layer 24a are equal absolute values but have different signs of plus and minus.

The liquid crystal polarization interference element 16 of the embodiment of the present invention has two or more liquid crystal layer sets 26. In this case, the plurality of liquid crystal layer sets 26 are arranged such that the bisectors of the angles formed between the slow axis direction of the first liquid crystal layer 20 and the slow axis direction of the second liquid crystal layer 24 are parallel to each other.

In the example shown in FIG. 1, all of the first liquid crystal layers 20 have the same configuration, and all of the second liquid crystal layers 24 also have the same configuration. That is, in the liquid crystal polarization interference element 16 shown in FIG. 1, all of the first liquid crystal layers 20 have equal in-plane retardations (Δnd's), equal angles of the in-plane slow axes, and the like, and all of the second liquid crystal layers 24 have equal in-plane retardations (Δnd's) and equal angles of the in-plane slow axes.

The light that passes through the liquid crystal polarization interference element 16 is repeatedly and alternately influenced by the slow axis at a certain angle possessed by the first liquid crystal layer 20 and the slow axis at an angle possessed by the second liquid crystal layer 24, both the slow axes having the same absolute value and different reference numerals.

Therefore, it is possible to form the liquid crystal polarization interference element 16 that acts as a λ/2 retardation plate for light in a specific wavelength range and does not act as a retardation plate for light in other wavelength ranges, that is, does not feel the retardation by setting Δnd's of the first liquid crystal layer 20 and the second liquid crystal layer 24 depending on the wavelength range transmitted through the filter 10, and adjusting the angles of the slow axes in the first liquid crystal layer 20 and the second liquid crystal layer 24 according to the total number of laminations of the first liquid crystal layers 20 and the second liquid crystal layers 24 in the liquid crystal polarization interference element 16.

As described above, the filter 10, in which the liquid crystal polarization interference element 16 acting as a λ/2 retardation plate only for light in a specific wavelength range is arranged between the first polarizer 12 and the second polarizer 14 arranged in a crossed nicols state, rotates the polarization direction of light having a specific wavelength among the linearly polarized light transmitted through the first polarizer 12 by 90° with the liquid crystal polarization interference element 16, and transmits the light through the second polarizer 14 arranged in a crossed nicols state with the first polarizer 12. On the other hand, since the liquid crystal polarization interference element 16 does not act as a retardation layer for light in a wavelength range other than the specific wavelength range, the linearly polarized light transmitted through the first polarizer 12 is transmitted through the liquid crystal polarization interference element 16 and shielded by the second polarizer 14. With such an optical action, the filter 10 functions as a band-pass filter that transmits only light in a specific wavelength range and shields other light.

Thus, the liquid crystal polarization interference element 16 acts as a λ/2 retardation plate only for light in a specific wavelength range. Accordingly, the in-plane retardations (Δnd's) of the first liquid crystal layer 20 and the second liquid crystal layer 24 are half the central wavelength (half-wavelength) of a wavelength range assumed to be transmitted through the filter 10, that is, a wavelength at which the liquid crystal polarization interference element 16 is assumed to act as a λ/2 retardation plate.

For example, in a case where the wavelength at which the liquid crystal polarization interference element 16 acts as a λ/2 retardation plate, that is, the central wavelength of a wavelength range transmitted through the filter 10 is assumed to be 550 nm, the Δnd's of the first liquid crystal layer 20 and the second liquid crystal layer 24 may be set to 275 nm. In a case where the first liquid crystal layer 20 consists of the first horizontally aligned liquid crystal layer 20H and the first vertically aligned liquid crystal layer 20V, the in-plane retardation of the first liquid crystal layer 20 is mainly caused by the first horizontally aligned liquid crystal layer 20H. Therefore, the And of the first horizontally aligned liquid crystal layer 20H may be set to 275 nm. Similarly, in a case where the second liquid crystal layer 24 consists of the second horizontally aligned liquid crystal layer 24H and the second vertically aligned liquid crystal layer 24V, the in-plane retardation of the second liquid crystal layer 24 is mainly caused by the second horizontally aligned liquid crystal layer 24H. Therefore, the Δnd of the second horizontally aligned liquid crystal layer 24H may be set to 275 nm.

Furthermore, the Δnd's of the first liquid crystal layer 20 and the second liquid crystal layer 24 may have an error of about +10% with respect to half the central wavelength of the wavelength range transmitted through the filter 10.

Here, in the liquid crystal polarization interference element 16 of the embodiment of the present invention, the absolute value of a sum of the in-plane retardations of the first horizontally aligned liquid crystal layers 20H of the first liquid crystal layer 20 is about 1.33 to 4 times, and preferably about 2 times the absolute value of a sum of the thickness-direction retardations of the first vertically aligned liquid crystal layers 20V. In addition, the absolute value of a sum of the in-plane retardations of the second horizontally aligned liquid crystal layers 24H of the second liquid crystal layer 24 is about 1.33 to 4 times, and preferably about 2 times the absolute value of a sum of the thickness-direction retardations of the second vertically aligned liquid crystal layers 24V.

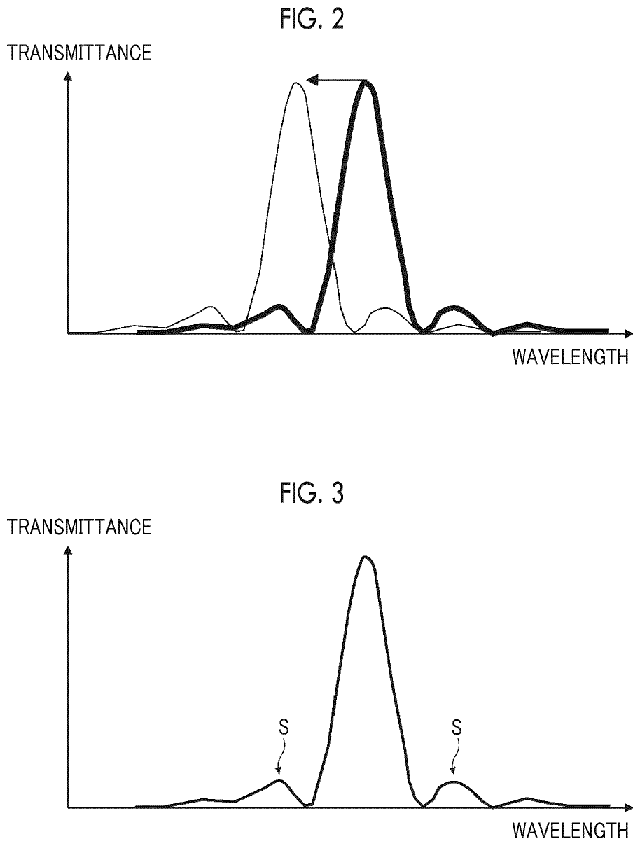

As described above, in the band-pass filter in the related art, there was a problem in that upon incidence of light from an oblique direction, a wavelength shift occurs, in which a transmission wavelength range moves toward the shorter wavelength side, as shown by the shift from the thick solid line to the thin solid line in FIG. 2, as compared with a case where light is incident from the front.

In contrast in the liquid crystal polarization interference element 16 of the embodiment of the present invention, each of the first liquid crystal layer 20 and the second liquid crystal layer 24 has a horizontally aligned liquid crystal layer (20H, 24H) and a vertically aligned liquid crystal layer (20V, 24V), and the absolute value of a sum of the in-plane retardations of the horizontally aligned liquid crystal layers is about 1.33 to 4 times, and preferably about 2 times the absolute value of a sum of the thickness-direction retardations of the vertically aligned liquid crystal layers. This enables each of the first liquid crystal layer 20 and the second liquid crystal layer 24 to reduce a difference between the phase difference that the liquid crystal layer imparts to light upon incidence of light from a vertical direction and the phase difference that the liquid crystal layer imparts to light upon incidence of light from an oblique direction. This makes it possible to suppress a wavelength shift upon incidence of light on the filter 10 from an oblique direction.

Furthermore, the in-plane retardation of the horizontally aligned liquid crystal layer (20H, 24H) can be measured using Axo Scan (OPMF-1, manufactured by Axometrics, Inc.).

In addition, the thickness-direction retardation of the vertically aligned liquid crystal layer (20V, 24V) can be measured using Axo Scan (OPMF-1, manufactured by Axometrics, Inc.). The in-plane retardation and the thickness-direction retardation can be separated and measured by optical analysis even in a state where the in-plane periodic structure layer and the thickness-direction periodic structure layer are laminated.

The number of the liquid crystal layer sets 26 in the liquid crystal polarization interference element 16 can be detected by obliquely cutting the liquid crystal polarization interference element 16 and analyzing the alignment direction of the liquid crystals on the surface of a cross section. This method is described in detail in “Depth-Dependent Determination of Molecular Orientation for WV-Film” (FMC8-3, IDW'04, 651 to 654) written by Yohei Takahashi et al.

In addition, the horizontally aligned liquid crystal layer and the vertically aligned liquid crystal layer of each of the first liquid crystal layer 20 and the second liquid crystal layer 24 in each liquid crystal layer set can be specified by obliquely cutting the liquid crystal polarization interference element 16 and analyzing the alignment direction of the liquid crystal compound on the surface of the cross section. This method is described in detail in the above-described document written by Yohei Takahashi et al.

In addition, the in-plane slow axis direction of the first liquid crystal layer 20, that is, the first horizontally aligned liquid crystal layer, and the in-plane slow axis direction of the second liquid crystal layer 24, that is, the second horizontally aligned liquid crystal layer in each liquid crystal layer set can be detected by obliquely cutting the liquid crystal polarization interference element 16 and analyzing the alignment direction of the liquid crystal compound on the surface of the cross section.

The in-plane retardation of each of the first liquid crystal layer 20 and the second liquid crystal layer 24 can be measured using AxoScan manufactured by Axometrics, Inc.

In the in-plane retardations (Δnd's) of the first liquid crystal layer 20 and the second liquid crystal layer 24, Δn is a birefringence of the rod-like liquid crystal compound 18 constituting the first liquid crystal layer 20 and the second liquid crystal layer 24. In addition, d represents the thickness of the first liquid crystal layer 20 and the second liquid crystal layer 24. Accordingly, the in-plane retardation may be determined by measuring the birefringence Δn of the rod-like liquid crystal compound 18 and the thickness d. Furthermore, the birefringence Δn of the liquid crystal compound can be measured using AxoScan manufactured by Axometrics, Inc.

For the angles of the slow axes in the first liquid crystal layer 20 and the second liquid crystal layer 24 constituting the liquid crystal polarization interference element 16 (the angles with respect to the transmission axes or the absorption axes of the polarizers as a reference), an optimal angle at which the liquid crystal polarization interference element 16 acts as a λ/2 retardation plate may be set by simulation according to the central wavelength of the wavelength range assumed to be transmitted through the filter 10 and a total number N of laminations of the first liquid crystal layers 20 and the second liquid crystal layers 24.

For the simulation, a general optical simulation unit can be used, or calculation can be performed using LCD Master 1D (manufactured by SHINTECH Co., Ltd., Ver 9.8.0.0).

The thickness d of each of the first liquid crystal layer 20 and the second liquid crystal layer 24 is not limited, and may be appropriately set to be a thickness that allows the in-plane retardation (Δnd) of each of the first liquid crystal layer 20 and the second liquid crystal layer 24 to be a half-wavelength of the central wavelength of the wavelength range transmitted through the filter 10.

The thickness d of each of the first liquid crystal layer 20 and the second liquid crystal layer 24 is preferably 1 to 5 μm, and more preferably 1 to 3 μm.

In addition, the thickness of each of the first horizontally aligned liquid crystal layer 20H and the first vertically aligned liquid crystal layer 20V in the first liquid crystal layer 20, and the thickness of each of the second horizontally aligned liquid crystal layer 24H and the second vertically aligned liquid crystal layer 24V in the second liquid crystal layer 24 are not limited, and the thickness may be appropriately set such that the absolute value of a sum of the in-plane retardations of the horizontally aligned liquid crystal layers (20H, 24H) is about 2 times the absolute value of a sum of the thickness-direction retardations of the vertically aligned liquid crystal layers (20V, 24V) depending on the liquid crystal compound used.

In a case where the first horizontally aligned liquid crystal layer 20H and the first vertically aligned liquid crystal layer 20V in the first liquid crystal layer 20 are formed of the same type of liquid crystal compound, that is, in a case where the first-1 rod-like liquid crystal compound 18ₕ₁ₐ and the first-2 rod-like liquid crystal compound 18ᵥ₁ₐ are of the same type, the thickness of the first horizontally aligned liquid crystal layer 20H may be set to be substantially 2 times the thickness of the first vertically aligned liquid crystal layer 20V in order to set the absolute value of a sum of the in-plane retardations of the first horizontally aligned liquid crystal layer 20H to be about 2 times the absolute value of a sum of the thickness-direction retardations of the first vertically aligned liquid crystal layer 20V. Similarly, in a case where the second horizontally aligned liquid crystal layer 24H and the second vertically aligned liquid crystal layer 24V in the second liquid crystal layer 24 are formed of the same type of liquid crystal compound, that is, in a case where the second-1 rod-like liquid crystal compound 18ₕ₂ₐ and the second-2 rod-like liquid crystal compound 18ᵥ₂ₐ are of the same type, the thickness of the second horizontally aligned liquid crystal layer 24H may be approximately 2 times the thickness of the second vertically aligned liquid crystal layer 24V in order to set the absolute value of a sum of the in-plane retardations of the second horizontally aligned liquid crystal layer 24H to be approximately 2 times the absolute value of a sum of the thickness-direction retardations of the second vertically aligned liquid crystal layer 24V.

Moreover, in a case where the first horizontally aligned liquid crystal layer 20H in the first liquid crystal layer 20 and the second horizontally aligned liquid crystal layer 24H in the second liquid crystal layer 24 are formed of the same type of liquid crystal compound, that is, in a case where the first-1 rod-like liquid crystal compound 18ₕ₁ₐ and the second-1 rod-like liquid crystal compound 18ₕ₂ₐ are of the same type, the thickness of the first horizontally aligned liquid crystal layer 20H and the thickness of the horizontally aligned liquid crystal layer 24H may be set to be substantially equal to each other in order to set the in-plane retardation of the first liquid crystal layer 20 and the in-plane retardation of the second liquid crystal layer 24 to be substantially equal to each other.

In addition, in the example shown in FIG. 1, one first liquid crystal layer 20 is configured such that one first horizontally aligned liquid crystal layer 20H and one first vertically aligned liquid crystal layer 20V are provided, but the present invention is not limited thereto. The first liquid crystal layer 20 may be configured to have a plurality of first horizontally aligned liquid crystal layers 20H and/or a plurality of first vertically aligned liquid crystal layers 20V. In a case of the configuration in which a plurality of first horizontally aligned liquid crystal layers 20H and/or a plurality of first vertically aligned liquid crystal layers 20V are provided, the sum of the in-plane retardations of the plurality of first horizontally aligned liquid crystal layers 20H may be approximately 2 times the sum of the thickness-direction retardations of the plurality of first vertically aligned liquid crystal layers 20V.

Similarly, in the example shown in FIG. 1, one second liquid crystal layer 24 is configured such that one second horizontally aligned liquid crystal layer 24H and one second vertically aligned liquid crystal layer 24V are provided, but the present invention is not limited thereto. The second liquid crystal layer 24 may be configured to have a plurality of second horizontally aligned liquid crystal layers 24H and/or a plurality of second vertically aligned liquid crystal layers 24V. In a case of the configuration in which a plurality of second horizontally aligned liquid crystal layers 24H and/or a plurality of second vertically aligned liquid crystal layers 24V are provided, the sum of the in-plane retardations of the plurality of second horizontally aligned liquid crystal layers 24H may be approximately 2 times the sum of the thickness-direction retardations of the plurality of second vertically aligned liquid crystal layers 24V. In this case, in one first liquid crystal layer and/or one second liquid crystal layer, by further dividing the horizontally aligned liquid crystal layer and the vertically aligned liquid crystal layer into thinner layers to increase the number of the horizontally aligned liquid crystal layers and the number of the vertically aligned liquid crystal layers, a difference between a retardation viewed from the front (normal direction) and a retardation viewed from a more oblique direction (direction of a large polar angle) can be reduced, which is thus desirable.

The total number of the first liquid crystal layers 20 and the second liquid crystal layers 24 laminated is not limited as long as the number of the liquid crystal layer sets 26 is 2 or more, that is, four or more layers are laminated, and further the number of layers laminated is an even number.

The total number of laminations of the first liquid crystal layers 20 and the second liquid crystal layers 24 is preferably 6 to 30, more preferably 6 to 20, and still more preferably 6 to 10. That is, the number of the liquid crystal layer sets 26 is preferably 3 to 15, more preferably 3 to 10, and still more preferably 3 to 5.

Furthermore, in the present invention, the larger the total number N of laminations of the first liquid crystal layers 20 and the second liquid crystal layers 24, that is, the larger the number of the liquid crystal layer sets 26, the narrower the wavelength range in which the liquid crystal polarization interference element 16 acts as a λ/2 retardation layer.

Accordingly, in the present invention, the larger the total number of laminations of the first liquid crystal layers 20 and the second liquid crystal layers 24, the narrower the half-width of the wavelength range of transmitted light. In other words, the filter 10 can be made as a band-pass filter having a narrower transmission wavelength range as the total number of laminations of the first liquid crystal layers 20 and the second liquid crystal layers 24 is increased.

Accordingly, as the total number of laminations of the first liquid crystal layers 20 and the second liquid crystal layers 24, that is, the number of the liquid crystal layer sets 26, a smaller number of layers may be selected for a case where a broad bandwidth is required, and a larger number of layers may be selected for a case where a narrow bandwidth is required, depending on a required width of the transmission wavelength range of the filter 10.

In the liquid crystal polarization interference element 16 shown in FIG. 1, all of the liquid crystal layer sets have the same configuration. That is, in the liquid crystal polarization interference element 16 shown in FIG. 1, all of the first liquid crystal layers 20 have the same configuration, and all of the second liquid crystal layers 24 also have the same configuration. That is, in the liquid crystal polarization interference element 16 shown in FIG. 1, all of the first liquid crystal layers 20 have equal in-plane retardations (Δnd's) and equal angles of the in-plane slow axes, and all of the second liquid crystal layers 24 have equal in-plane retardations (Δnd's) and equal angles of the in-plane slow axes.

However, the present invention is not limited thereto, and the liquid crystal layers may have a distribution of the in-plane retardations (Δnd's) and a distribution of the angles of the in-plane slow axes in the thickness direction. That is, in the present invention, in a case where the first liquid crystal layer and the second liquid crystal layer have equal in-plane retardations (Δnd's) and equal values of the angles of the in-plane slow axes for the respective the liquid crystal layer sets, the in-plane retardations (Δnd's) and/or the angles of the in-plane slow axes of the first liquid crystal layer and the second liquid crystal layer may differ from each other for the respective liquid crystal layer sets.

As an example, a configuration is exemplified, in which three or more liquid crystal layer sets are provided in the thickness direction, and the in-plane retardation (Δnd) and the angle between the in-plane slow axes of the first liquid crystal layer and the second liquid crystal layer, that is, the angle formed between the in-plane slow axis of the first liquid crystal layer and the in-plane slow axis of the second liquid crystal layer differ between the liquid crystal layer sets in the center in the thickness direction (lamination direction) and the liquid crystal layer sets on both sides in the thickness direction.

Specifically, the in-plane retardations (Δnd's) of the liquid crystal layers (the first liquid crystal layers and the second liquid crystal layers) of the liquid crystal layer sets on both sides in the thickness direction may be increased and the absolute values of the angles of the in-plane slow axes may be decreased, as compared with the liquid crystal layers (the first liquid crystal layers and the second liquid crystal layers) of the liquid crystal layer sets in the center in the thickness direction.

As will be described in Examples later, for example, in a case where the liquid crystal polarization interference element has eight liquid crystal layers, that is, four liquid crystal layer sets, a configuration is exemplified, in which
in the first liquid crystal layer set, the in-plane retardation and the angle of the in-plane slow axis of the first liquid crystal layer (first layer) are denoted by Δnd1 and θ1, respectively, and the in-plane retardation and the angle of the in-plane slow axis of the second liquid crystal layer (second layer) are denoted by Δnd1 and −θ1, respectively,
in the second liquid crystal layer set, the in-plane retardation and the angle of the in-plane slow axis of the first liquid crystal layer (third layer) are denoted by Δnd2 that is smaller than Δnd1, and θ2 that is larger than θ1, respectively, and the in-plane retardation and the angle of the in-plane slow axis of the second liquid crystal layer (fourth layer) are denoted by Δnd2 and −θ2, respectively,
in the third liquid crystal layer set, the in-plane retardation and the angle of the in-plane slow axis of the first liquid crystal layer (fifth layer) are denoted by Δnd2 and θ2, respectively, and the in-plane retardation and the angle of the in-plane slow axis of the second liquid crystal layer (sixth layer) are denoted by Δnd2 and −θ2, respectively, and
in the fourth liquid crystal layer set, the in-plane retardation and the angle of the in-plane slow axis of the first liquid crystal layer (seventh layer) are denoted by Δnd1 and θ1, respectively, and the in-plane retardation and the angle of the in-plane slow axis of the second liquid crystal layer (eighth layer) are denoted by Δnd1 and −θ1, respectively.

In the band-pass filter, as conceptually shown in FIG. 3, a transmission wavelength region, which is called a side lobe, is generated as shown by the arrow S in the drawing at a position of a shorter wavelength and a position of a longer wavelength than a target transmission wavelength range, with the target transmission wavelength range being sandwiched.

In contrast, the side lobe can be reduced by increasing the in-plane retardations and decreasing the angle of the in-plane slow axis in the liquid crystal layers of the liquid crystal layer sets on both sides in the thickness direction, as compared with the liquid crystal layers of the liquid crystal layer sets in the center in the thickness direction, as described above.

Furthermore, the in-plane retardation of the liquid crystal layer may be adjusted, for example, by changing the thickness of the liquid crystal layer, but may also be adjusted by changing the liquid crystal compound to be used.

In such a configuration in which the in-plane retardations are increased and the angles of the in-plane slow axes are decreased in the liquid crystal layers of the liquid crystal layer sets in both sides in the thickness direction, as compared with the liquid crystal layers of the liquid crystal layer sets in the center in the thickness direction, there is no limit on the number of the liquid crystal layers in the center, with which the in-plane retardations are increased and the angles of the in-plane slow axes are decreased in the liquid crystal layers, as compared with the both sides. That is, there is no limit on how to divide the liquid crystal layer sets between the both sides and the center, and thus, the number or the division can be appropriately set depending on the number of the liquid crystal layers (liquid crystal layer sets) included in the filter.

In addition, with regard to the in-plane retardations and the angles of the in-plane slow axes of the liquid crystal layers of the liquid crystal layer sets on both sides in the thickness direction, and the in-plane retardations and the angles of the in-plane slow axes of the liquid crystal layers of the liquid crystal layer sets in the center in the thickness direction, optimum in-plane retardations and angles of the in-plane slow axes, with which the liquid crystal polarization interference element acts as a λ/2 retardation plate and the side lobe can be reduced, may be set by simulation.

Furthermore, it is preferable that the change in angles of the in-plane slow axes of the liquid crystal layers of the liquid crystal layer sets from both sides to the center in the lamination direction (thickness direction), and the distribution of the in-plane retardations of the liquid crystal layers of the liquid crystal layer sets in the thickness direction are controlled as gently and finely as possible.

In the filter 10 shown in FIG. 1, in each liquid crystal layer set, both of the liquid crystal compounds constituting the first horizontally aligned liquid crystal layer 20H and the liquid crystal compounds constituting the first vertically aligned liquid crystal layer 20V in the first liquid crystal layer 20 are rod-like liquid crystal compounds, and both of the liquid crystal compounds constituting the second horizontally aligned liquid crystal layer 24H and the liquid crystal compounds constituting the second vertically aligned liquid crystal layer 24V in the second liquid crystal layer 24 are rod-like liquid crystal compounds. However, the present invention is not limited thereto.

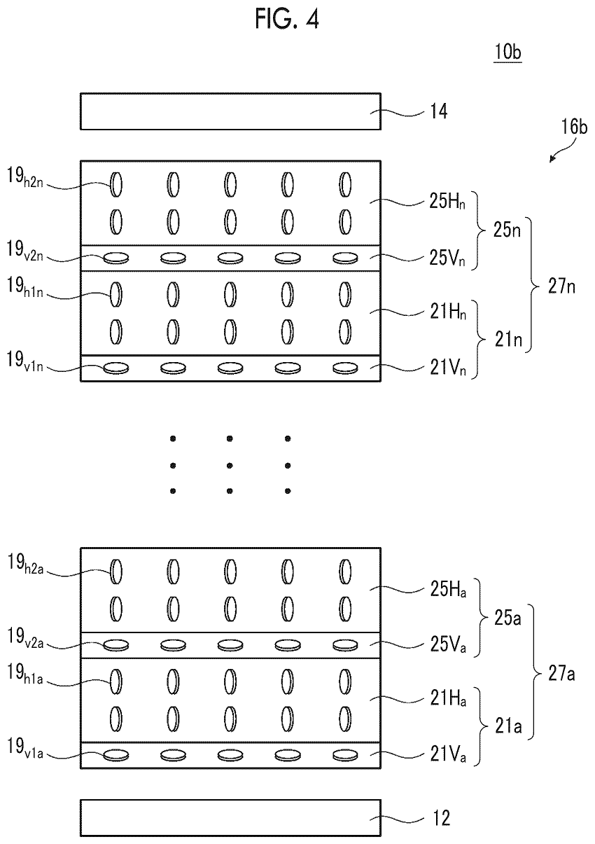

For example, as in the liquid crystal polarization interference element 16b of the filter 10b shown in FIG. 4, both of the liquid crystal compounds constituting the first horizontally aligned liquid crystal layer 21H of the first liquid crystal layer 21 and the liquid crystal compounds constituting the first vertically aligned liquid crystal layer 21V may be the disk-like liquid crystal compounds 19, and both of the liquid crystal compounds constituting the second horizontally aligned liquid crystal layer 25H of the second liquid crystal layer 25 and the liquid crystal compounds constituting the second vertically aligned liquid crystal layer 25V may be the disk-like liquid crystal compounds 19.

The direction of the optical axis of the disk-like liquid crystal compound is a direction perpendicular to the disk plane. Therefore, as shown in FIG. 4, for example, since the first-1 disk-like liquid crystal compounds 19ₕ₁ₐ constituting the first horizontally aligned liquid crystal layer 21Ha of the first liquid crystal layer 21a of the first liquid crystal layer set 27a are aligned such that optical axes thereof are parallel to the main surface of the first horizontally aligned liquid crystal layer 21Ha, the disk plane is aligned perpendicular to the main surface. In addition, as shown in FIG. 4, in the first horizontally aligned liquid crystal layer 21Ha, each of the first-1 disk-like liquid crystal compounds 19ₕ₁ₐ is aligned such that an optical axis thereof is aligned in one predetermined direction. That is, the first horizontally aligned liquid crystal layer 21Ha is a so-called (negative) A-plate.

In addition, since the first-2 disk-like liquid crystal compounds 19ᵥ₁ₐ constituting the first vertically aligned liquid crystal layer 21Va of the first liquid crystal layer 21a are aligned such that optical axes thereof are perpendicular to the main surface of the first vertically aligned liquid crystal layer 21Va, the disk plane is aligned parallel to the main surface. That is, the first vertically aligned liquid crystal layer 21Va is a so-called (negative)C-plate.

Also in the first liquid crystal layer 21a including the first horizontally aligned liquid crystal layer 21Ha and the first vertically aligned liquid crystal layer 21Va formed of such disk-like liquid crystal compounds, the absolute value of a sum of the in-plane retardations of the first horizontally aligned liquid crystal layer 21Ha is 1.33 to 4 times, and preferably about 2 times the absolute value of a sum of the thickness-direction retardations of the first vertically aligned liquid crystal layer 21Va.

Similarly, as shown in FIG. 4, since the second-1 disk-like liquid crystal compounds 19ₕ₂ₐ constituting the second horizontally aligned liquid crystal layer 25Ha of the second liquid crystal layer 25a of the first liquid crystal layer set 27a are aligned such that optical axes thereof are parallel to the main surface of the second horizontally aligned liquid crystal layer 25Ha, the disk plane is aligned perpendicular to the main surface. In addition, as shown in FIG. 4, in the second horizontally aligned liquid crystal layer 25Ha, each of the second-1 disk-like liquid crystal compounds 19ₕ₂ₐ is aligned such that an optical axis thereof is aligned in a predetermined in-plane direction. That is, the second horizontally aligned liquid crystal layer 25Ha is a so-called (negative) A-plate.

In addition, since the second-2 disk-like liquid crystal compounds 19ᵥ₂ₐ constituting the second vertically aligned liquid crystal layer 25Va of the second liquid crystal layer 25a are aligned such that optical axes thereof are perpendicular to the main surface of the second vertically aligned liquid crystal layer 25Va, the disk plane is aligned parallel to the main surface. That is, the second vertically aligned liquid crystal layer 25Va is a so-called (negative)C-plate.

Even in the second liquid crystal layer 25a including the second horizontally aligned liquid crystal layer 25Ha and the second vertically aligned liquid crystal layer 25Va formed of such a disk-like liquid crystal compound, the absolute value of a sum of the in-plane retardations of the second horizontally aligned liquid crystal layer 25Ha is 1.33 to 4 times, and preferably about 2 times the absolute value of a sum of the thickness-direction retardations of the second vertically aligned liquid crystal layer 25Va.

In the first liquid crystal layer set 27a, the in-plane slow axis of the first liquid crystal layer 21a and the in-plane slow axis of the second liquid crystal layer 25a intersect with each other.

The direction of the in-plane slow axis of the first liquid crystal layer 21a is mainly due to the alignment direction of the first-1 disk-like liquid crystal compounds 19ₕ₁ₐ in the first horizontally aligned liquid crystal layer 21Ha. Similarly, the in-plane slow axis direction of the second liquid crystal layer 25a is mainly due to the alignment direction of the second-1 disk-like liquid crystal compounds 19ₕ₂ₐ in the second horizontally aligned liquid crystal layer 25Ha.

Accordingly, as shown in FIG. 4, the first liquid crystal layer 21a and the second liquid crystal layer 25a are laminated such that the alignment direction (optical axis) of the first-1 disk-like liquid crystal compounds 19ₕ₁ₐ in the first horizontally aligned liquid crystal layer 21Ha and the alignment direction (optical axis) of the second-1 disk-like liquid crystal compounds 19ₕ₂ₐ in the second horizontally aligned liquid crystal layer 25Ha intersect with each other.

In addition, in the first liquid crystal layer set 27a, the in-plane retardation of the first liquid crystal layer 21a and the in-plane retardation of the second liquid crystal layer 25a are substantially equal to each other.

The liquid crystal polarization interference element 16b has two or more liquid crystal layer sets 27. In this case, the plurality of liquid crystal layer sets 27 are arranged such that bisectors of the angles formed between the slow axis direction of the first liquid crystal layer 21 and the slow axis direction of the second liquid crystal layer 25 are parallel to each other.

This enables the liquid crystal polarization interference element 16b to act as a λ/2 retardation plate only for light in a specific wavelength range. Therefore, the filter 10 in which the liquid crystal polarization interference element 16b is arranged between the first polarizer 12 and the second polarizer 14 is a band-pass filter that transmits only light in a specific wavelength range and shields the other light.

In this case, in the liquid crystal polarization interference element 16b of the embodiment of the present invention, each of the first liquid crystal layer 21 and the second liquid crystal layer 25 has a horizontally aligned liquid crystal layer (21H, 25H) and a vertically aligned liquid crystal layer (21V, 25V), and the absolute value of a sum of the in-plane retardations of the horizontally aligned liquid crystal layers is 1.33 to 4 times, and preferably about 2 times the absolute value of a sum of the thickness-direction retardations of the vertically aligned liquid crystal layers. This enables each of the first liquid crystal layer 21 and the second liquid crystal layer 25 to reduce a difference between the phase difference that the liquid crystal layer imparts to light upon incidence of light from a vertical direction and the phase difference that the liquid crystal layer imparts to light upon incidence of light from an oblique direction. This makes it possible to suppress a wavelength shift upon incidence of light on the filter 10 from an oblique direction.

Furthermore, in the example shown in FIG. 1, all of the liquid crystal layers are formed of rod-like liquid crystal compounds, and in the example shown in FIG. 4, all of the liquid crystal layers are formed of disk-like liquid crystal compounds. However, the present invention is not limited thereto.

For example, both of the liquid crystal compounds constituting the first horizontally aligned liquid crystal layer 20H and the first vertically aligned liquid crystal layer 20V of the first liquid crystal layer 20 may be rod-like liquid crystal compounds, and both of the liquid crystal compounds constituting the second horizontally aligned liquid crystal layer 25H and the second vertically aligned liquid crystal layer 25V of the second liquid crystal layer 25 may be disk-like liquid crystal compounds. Alternatively, both of the liquid crystal compounds constituting the first horizontally aligned liquid crystal layer 21H and the first vertically aligned liquid crystal layer 21V of the first liquid crystal layer 21 may be disk-like liquid crystal compounds, and both of the liquid crystal compounds constituting the second horizontally aligned liquid crystal layer 24H and the second vertically aligned liquid crystal layer 24V of the second liquid crystal layer 24 may be rod-like liquid crystal compounds.

In addition, while being not limited to a configuration in which the liquid crystal compounds constituting the first horizontally aligned liquid crystal layers and the first vertically aligned liquid crystal layers of the first liquid crystal layers of all of the liquid crystal layer sets are all rod-like liquid crystal compounds or all disk-like liquid crystal compounds, the first horizontally aligned liquid crystal layer and the first vertically aligned liquid crystal layer of the first liquid crystal layer of one liquid crystal layer set may be formed of rod-like liquid crystal compounds, and the first horizontally aligned liquid crystal layer and the first vertically aligned liquid crystal layer of the first liquid crystal layer of another liquid crystal layer set may be formed of disk-like liquid crystal compounds. Similarly, while being not limited to a configuration in which the liquid crystal compounds constituting the second horizontally aligned liquid crystal layers and the second vertically aligned liquid crystal layers of the second liquid crystal layers of all of the liquid crystal layer sets are all rod-like liquid crystal compounds or all disk-like liquid crystal compounds, the second horizontally aligned liquid crystal layer and the second vertically aligned liquid crystal layer of the second liquid crystal layer of one liquid crystal layer set may be formed of rod-like liquid crystal compounds, and the second horizontally aligned liquid crystal layer and the second vertically aligned liquid crystal layer of the second liquid crystal layer of another liquid crystal layer set may be formed of disk-like liquid crystal compounds.

In addition, in the examples shown in FIGS. 1 and 4, the first liquid crystal layer and the second liquid crystal layer are configured such that the vertically aligned liquid crystal layer and the horizontally aligned liquid crystal layer are laminated in this order from the first polarizer 12 side. However, the present invention is not limited thereto, and the first liquid crystal layer and the second liquid crystal layer may also be configured such that the horizontally aligned liquid crystal layer and the vertically aligned liquid crystal layer are laminated in this order from the first polarizer 12 side.

Furthermore, the liquid crystal polarization interference element of the embodiment of the present invention may be configured such that the first liquid crystal layer and the second liquid crystal layer may be formed by a coating method and directly laminated, or may be configured such that a sheet-like first liquid crystal layer and a sheet-like second liquid crystal layer are manufactured, alternately laminated, and bonded with an optical bonding layer which is transparent to transmitted light, such as an optical clear adhesive (OCA), an acrylic pressure sensitive adhesive, an adhesive, and a polymer layer. In this case, the refractive index of the optical bonding layer is preferably close to the refractive index of the liquid crystal layer from the viewpoint of improving a transmittance. Specifically, the difference in refractive index is preferably 0.3 or less. In addition, the refractive index of the optical bonding layer is desirably a value between two birefringence indices of the liquid crystal layers since the difference in refractive index is small from either of the two birefringence indices. From the viewpoint of the transmittance of transmitted light, direct lamination by a coating method, which does not have a bonding layer or the like, is preferable.

The liquid crystal polarization interference element may be manufactured by a known method.

For example, it is manufactured by a coating method using a liquid crystal composition for forming the first liquid crystal layer and the second liquid crystal layer.

In addition, the first liquid crystal layer and the second liquid crystal layer can be formed by forming each of the horizontally aligned liquid crystal layer and the vertically aligned liquid crystal layer, then laminating the layers, and bonding the layers with an adhesive which is transparent to transmitted light, such as an optical clear adhesive (OCA) and an acrylic pressure sensitive adhesive. Alternatively, the vertically aligned liquid crystal layer may be formed on the horizontally aligned liquid crystal layer after the horizontally aligned liquid crystal layer is formed, or the horizontally aligned liquid crystal layer may be formed on the vertically aligned liquid crystal layer after the vertically aligned liquid crystal layer is formed. These methods are described in detail in JP6276393B.

The horizontally aligned liquid crystal layer can be manufactured by a method for forming a horizontally aligned liquid crystal layer, which is known in the related art.

As an example, first, an alignment film aligned in one direction is formed on a support appropriately selected.

As the alignment film, known alignment films can be used, such as a rubbed film consisting of an organic compound such as a polymer, an obliquely vapor-deposited film of an inorganic compound, a film having microgrooves, and a film obtained by accumulating a Langmuir-Blodgett (LB) film of an organic compound such as ω-tricosanoic acid, dioctadecylmethylammonium chloride, and methyl stearate by a Langmuir-Blodgett method, and a film obtained by applying a coating liquid for forming an alignment film containing a photo alignment material to a surface of a support, drying the coating liquid, and exposing the coating film using a polarizer such as a wire grid polarizer.

On the other hand, a composition (liquid crystal composition) for forming a horizontally aligned liquid crystal layer, which includes a liquid crystal compound, is prepared.

Furthermore, a solvent for preparing the composition is not limited and can be appropriately selected depending on the purpose, but is preferably an organic solvent. The organic solvent is not particularly limited and can be appropriately selected depending on the purpose. Examples of the organic solvent include ketones, alkyl halides, amides sulfoxides, a heterocyclic compound, hydrocarbons, esters, and ethers. These may be used alone or in combination of two or more kinds thereof. Among these, the ketones are preferable in consideration of an environmental burden.

The composition for forming a horizontally aligned liquid crystal layer is applied to a surface of the formed alignment film to align the liquid crystal compound, and is further dried. The composition is cured by ultraviolet irradiation or the like as necessary to form a horizontally aligned liquid crystal layer.

The vertically aligned liquid crystal layer can be manufactured by a method for forming a vertically aligned liquid crystal layer, which is known in the related art.

With regard to the details of the method for manufacturing a vertically aligned liquid crystal layer (positive C-plate) in which rod-like liquid crystal compounds are vertically aligned, reference can be made to the description in, for example, JP2017-187732A, JP2016-053709A, JP2015-200861A, and the like. In addition, for the details of the method for manufacturing a vertically aligned layer (negative C-plate) in which the disk-like liquid crystal compound is vertically aligned, reference can be made to, for example, the descriptions in JP6001505B.

Each of a first liquid crystal layer and a second liquid crystal layer can be manufactured by bonding the horizontally aligned liquid crystal layer and the vertically aligned liquid crystal layer manufactured as described above with OCA or the like.

Next, the manufactured first liquid crystal layer and second liquid crystal layer are bonded with OCA or the like such that the angle of the in-plane slow axis is a predetermined angle, thereby forming a liquid crystal layer set. A plurality of such liquid crystal layer sets are manufactured, and the liquid crystal layer sets are further laminated to manufacture a liquid crystal polarization interference element. In a case of laminating the liquid crystal layer sets, the liquid crystal layer sets may be adhered to each other with OCA or the like, and laminated. In addition, during the lamination of the liquid crystal layer sets, the liquid crystal layer sets are laminated such that the bisectors of the angles formed between the in-plane slow axes of the first liquid crystal layers and the in-plane slow axes of the second liquid crystal layers in the respective liquid crystal layer sets are parallel to each other.

The liquid crystal polarization interference element manufactured as described above is arranged, for example, such that the transmission axis of the first polarizer, and the bisector of an angle formed between the in-plane slow axis of the first liquid crystal layer and the in-plane slow axis of the second liquid crystal layer of each liquid crystal layer set are parallel to each other, and further, the second polarizer is arranged in a crossed nicols state with the first polarizer, whereby a filter as shown in FIG. 1 or FIG. 4 can be manufactured.

In the liquid crystal polarization interference element 16 of the embodiment of the present invention, the rod-like liquid crystal compound 18 is not limited and various known liquid crystal compounds can be used.

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used.

As the rod-like liquid crystal compound, not only the low-molecular-weight liquid crystal molecules as described above but also high-molecular-weight liquid crystal molecules can be used.

It is preferable that the alignment of the rod-like liquid crystal compound is immobilized by polymerization, and as the polymerizable rod-like liquid crystal compound, the compounds described in Makromol. Chem., Vol. 190, p. 2255 (1989), Advanced Materials, Vol. 5, p. 107 (1993), U.S. Pat. Nos. 4,683,327A, 5,622,648A, 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-64627A, and the like can be used. Furthermore, as the rod-like liquid crystal compound, for example, the compounds described in JP1999-513019A (JP-H11-513019A) and JP2007-279688A can also be preferably used.

In addition, in the liquid crystal polarization interference element 16 of the embodiment of the present invention, the disk-like liquid crystal compound 19 is not limited and various known liquid crystal compounds can be used.

As the disk-like liquid crystal compound, for example, the compounds described in JP2007-108732A and JP2010-244038A can be preferably used.

In addition to the liquid crystal compound, a polymerization initiator, a leveling agent, a crosslinking agent, a surfactant, or the like may be added to the composition for forming the first liquid crystal layer 20 and the second liquid crystal layer 24, as necessary.

In the present invention, the first liquid crystal layer and the second liquid crystal layer may include an infrared absorbing colorant.

In a case where the first liquid crystal layer and the second liquid crystal layer contain the infrared absorbing colorant, it is possible to make the wavelength dispersibility in the liquid crystal layer strongly normal dispersion. As a result, it is possible to narrow the wavelength range of light on which the liquid crystal polarization interference element acts as a λ/2 wavelength plate. That is, by adding the infrared absorbing colorant to the first liquid crystal layer and the second liquid crystal layer and making the wavelength dispersibility in the liquid crystal layer strongly normal dispersion, it is possible to obtain a band-pass filter having a narrower transmission wavelength range. Furthermore, the term “forward dispersion” (forward wavelength dispersion) means that the larger the measurement wavelength, the smaller the phase difference.

As the infrared absorbing colorant, various infrared absorbing colorants that can reduce a difference in refractive index between the x direction and the y direction by being aligned in the same direction as the liquid crystal compound can be used.

The infrared absorbing colorant is not particularly limited as long as it is a colorant that absorbs infrared rays (for example, light having a wavelength of 700 to 900 nm). Among these, the infrared absorbing colorant is preferably a dichroic colorant. Furthermore, the dichroic colorant refers to a colorant having a property that an absorbance in the long axis direction and an absorbance in the short axis direction in the molecule are different from each other.

As the infrared absorbing colorant, diketopyrrolopyrrole-based colorants, diimmonium-based colorants, phthalocyanine-based colorants, naphthalocyanine-based colorants, azo-based colorants, polymethine-based colorants, anthraquinone-based colorants, pyrylium-based colorants, squarylium-based colorants, triphenylmethane-based colorants, cyanine-based colorants, and aminium-based colorants.

In addition, as the infrared absorbing colorant, a metal complex colorant and a boron complex-based colorant can also be used.

The infrared absorbing colorant is described in detail in WO2019/044859A.

The amount of the infrared absorbing colorant to be added in the first liquid crystal layer and the second liquid crystal layer is not particularly limited, and may be appropriately set depending on the width of the transmission wavelength range required for the band-pass filter and the like.

In the present invention, the first liquid crystal layer and the second liquid crystal layer may contain a liquid crystal elastomer.

With regard to the first liquid crystal layer and the second liquid crystal layer, including the liquid crystal elastomer, even in a case where the liquid crystal layer is formed using the liquid crystal elastomer, the liquid crystal layer formed of a usual liquid crystal compound that is not an elastomer may include the liquid crystal elastomer.

In this manner, in a case where the first liquid crystal layer and the second liquid crystal layer include a liquid crystal elastomer, the first liquid crystal layer and the second liquid crystal layer can have elasticity, and the thickness of the liquid crystal layer can be changed by stretching or contracting the filter in the plane direction.

The Δnd of the liquid crystal layer can be changed by changing the thickness of the liquid crystal layer. As a result, in the band-pass filter, it is possible to change the wavelength range of light transmitted through the filter. That is, in a case where the first liquid crystal layer and the second liquid crystal layer include a liquid crystal elastomer, the wavelength range can vary by stretching and contracting the liquid crystal layer, that is, the filter, and thus, it is possible to actively control the wavelength in the band-pass filter.

The liquid crystal elastomer is not limited and various known liquid crystal elastomers can be used.

As the liquid crystal elastomer, for example, a liquid crystal elastomer prepared using a liquid crystal monomer, a chiral agent, a crosslinking agent, and a plasticizer, described in JP2020-131638A, can be used. Therefore, mechanical properties are imparted to the liquid crystal elastomer, and rubber elasticity is given, which makes deformation according to an external force that is necessary for active wavelength control possible.

Furthermore, in a case where the first liquid crystal layer and the second liquid crystal layer are formed of common liquid crystal compounds that are not elastomers, and a liquid crystal elastomer is added to impart elasticity, the amount of the liquid crystal elastomer to be added is not limited, and may be appropriately set depending on required elasticity, that is, a control range of the transmission wavelength range.

Such a liquid crystal polarization interference element and filter of the embodiments of the present invention can be used at any wavelength. That is, the liquid crystal polarization interference element and the filter of the embodiments of the present invention can be used for any electromagnetic waves such as ultraviolet rays, visible light, infrared rays, terahertz waves, and millimeter waves.

In the filter of the embodiment of the present invention, the transmission axes of the polarizers arranged in a crossed nicols state are set to an appropriate angle in order to preferably obtain desired band-pass characteristics. In particular, it is possible to reduce the size of the side lobe generated on both sides of the main band-pass wavelength (the longer wave side and the shorter wave side) and to adjust the sizes of the side lobes on the longer wave side and the shorter wave side to be equal.

In the filter of the embodiment of the present invention, a retardation layer can be provided on one side or both sides of the polarizers arranged in a crossed nicols state. This retardation layer brings about an effect of maintaining the orthogonal relationship of the polarization direction by the linear polarizer arranged in a crossed nicols state not only in the front but also in an off-axis direction of the polarizer, that is, a direction tilted from the front in an oblique direction at 45 degrees at an orientation different from the orientation of the transmission axis and/or absorption axis of the polarizer. This makes it possible to obtain good band-pass characteristics that are the same as those in the front even in the oblique direction. By setting the in-plane slow axis of the retardation layer parallel to an absorption axis of any of the set of the polarizers arranged in a crossed nicols state, the polarization state can be compensated to maintain the orthogonal relationship of the polarization direction in the oblique direction without giving an influence on the front. As the retardation layer, a positive C-plate in which rod-like liquid crystal compounds are vertically aligned and a positive A-plate in which rod-like liquid crystal compounds are horizontally aligned, a negative C-plate formed of disk-like liquid crystals and a negative A-plate formed of a disk-like liquid crystals, or a combination thereof is used. Alternatively, a B-plate (with an Nz factor of 0.1 to 0.9) that is a biaxial refractive index body can also be used.

In addition, the configuration of the filter using the liquid crystal polarization interference element of the embodiment of the present invention is not limited to a configuration in which the liquid crystal polarization interference element is arranged between the two polarizers arranged in a crossed nicols state. For example, the filter of the embodiment of the present invention may be configured such that the liquid crystal polarization interference element of the embodiment of the present invention is arranged between two polarizers arranged in a parallel nicols state. That is, the filter of the embodiment of the present invention may be configured such that the liquid crystal polarization interference element is arranged between two polarizers that are arranged such that transmission axes thereof are parallel to each other. In this case, it is preferable that the liquid crystal polarization interference element is configured such that liquid crystal layers having the same thickness and having angles formed between the direction of the transmission axis of the polarizer and the slow axis of ρ, 3ρ, 5ρ, . . . are laminated. The liquid crystal polarization interference element having such a configuration is also referred to as a Solc filter (or fan Solc filter).

Hereinabove, the liquid crystal polarization interference element and the filter of the embodiments of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail with reference to Examples. The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited to specific examples shown below.

### Comparative Example 1

### (Formation of Alignment Film)

A glass substrate was prepared as a support. The following coating liquid for forming an alignment film was applied onto the support by spin coating. The support on which the coating film of the coating liquid for forming an alignment film was formed was dried for 60 seconds on a hot plate at 60° C. to form an alignment film P-1.

Coating liquid for forming alignment film

| | | |
|---|---|---|
| Material for photo alignment below | 1.00 | part by mass |
| Water | 16.00 | parts by mass |
| Butoxyethanol | 42.00 | parts by mass |
| Propylene glycol monomethyl ether | 42.00 | parts by mass |

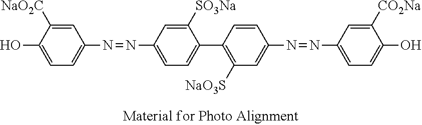

### (Exposure of Alignment Film)

Next, using an ultraviolet exposure device, the alignment film P-1 was irradiated with linearly polarized ultraviolet rays by a wire grid polarizer (ProFlux PPL02, manufactured by Moxtek, Inc.) installed so that the angle of an absorption axis was q1 (=) 0°, thereby obtaining an alignment film P-2. For the ultraviolet rays, the illuminance was set to 4.5 mW/cm² and the integrated irradiation amount was set to 300 mJ/cm².

Furthermore, the angle of the absorption axis is an angle with respect to the longitudinal direction of the substrate, and clockwise is defined as positive.

### (Formation of Horizontally Aligned Liquid Crystal Layer Using Rod-Like Liquid Crystal Compound)

As a liquid crystal composition forming a horizontally aligned liquid crystal layer, the following composition B-1 was prepared.

Composition B-1

| | | |
|---|---|---|
| Rod-like liquid crystal compound L-1 below | 100.00 | parts by mass |
| Polymerization initiator (Irgacure | 3.00 | parts by mass |
| (registered trade name) 907, manufactured | | |
| by BASF SE) | | |
| Photosensitizer (KAYACURE DETX-S, | 1.00 | part by mass |
| manufactured by Nippon Kayaku Co., Ltd.) | | |
| Leveling agent T-1 below | 0.08 | parts by mass |
| Methyl ethyl ketone | 2,000.00 | parts by mass |

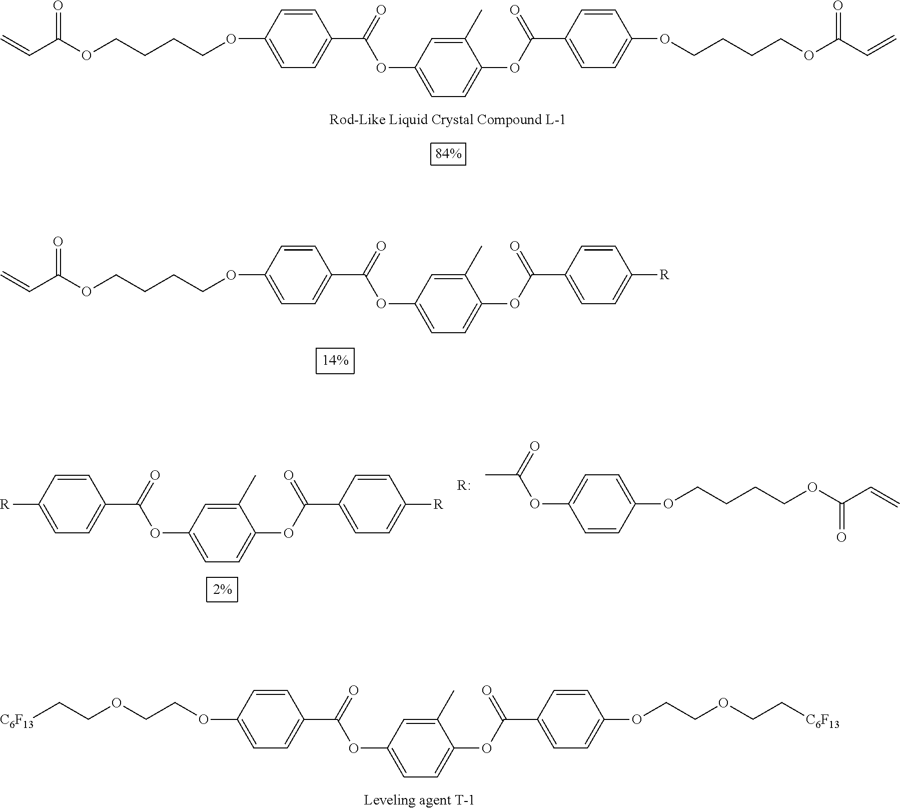

The horizontally aligned liquid crystal layer was formed by applying the composition B-1 onto the alignment film P-2. That is, first, the composition B-1 was applied onto the alignment film P-2, and the film was heated and then cured with ultraviolet rays to manufacture a liquid crystal immobilized layer.

To describe in more details, the liquid crystal immobilized layer was manufactured by applying the composition B-1 to the alignment film P-2 to obtain a coating film, the coating film was heated on a hot plate at 80° C., and then the coating film was irradiated with ultraviolet rays having a wavelength of 365 nm at an irradiation dose of 300 mJ/cm² using a high-pressure mercury lamp under a nitrogen atmosphere at 80° C. to immobilize the alignment of the liquid crystal compound. The thickness of the horizontally aligned liquid crystal layer after the immobilization was 1.72 μm.

After forming the horizontally aligned liquid crystal layer by the above-described method, the horizontally aligned liquid crystal layer was peeled off from the photo alignment film. The formed horizontally aligned liquid crystal layer was confirmed to have the characteristics shown in Table 1 using AxoScan (manufactured by Axometrics, Inc.). Furthermore, in Table 1, Re represents an in-plane retardation.

Eight such horizontally aligned liquid crystal layers were manufactured.

TABLE 1

| Thickness d | | Re |
|---|---|---|
| μm | Birefringence Δn | nm |
| 1.72 | 0.16 | 275 |

Using the one horizontally aligned liquid crystal layer manufactured as described above as the first liquid crystal layer and the second liquid crystal layer, the two horizontally aligned liquid crystal layers were bonded using a pressure sensitive adhesive (SK Dyne 2057, manufactured by Soken Chemical & Engineering Co., Ltd.) such that the angle formed between the in-plane slow axes was 11.25°, that is, the angles with respect to the bisector of the angle formed between the in-plane slow axes were +5.625° and −5.625°, respectively, to manufacture a liquid crystal layer set. Four liquid crystal layer sets were formed in the same manner.

The four liquid crystal layer sets were bonded to each other using a pressure sensitive adhesive (SK Dyne 2057, manufactured by Soken Chemical & Engineering Co., Ltd.) to manufacture a liquid crystal polarization interference element. In this case, the liquid crystal layers were laminated such that the bisector of the angle formed between the in-plane slow axes in each of the liquid crystal layer sets was parallel to the bisector of the angle formed between the in-plane slow axes in each of the liquid crystal layer sets.

A filter was manufactured by laminating two polarizers arranged in a crossed nicols state to sandwich the manufactured liquid crystal polarization interference element. In this case, the liquid crystal layers were laminated such that the transmission axis of one polarizer and the bisector of an angle formed between the in-plane slow axes in each liquid crystal layer set were parallel to each other.

### Evaluation

For the manufactured filter, a wavelength shift value and a side lobe value were measured using a spectroradiometer “SR-3” manufactured by Topcon Technohouse Corporation. First, a peak wavelength (central wavelength) and a half-width of transmitted light in a case where light was incident from a polar angle of 0° (direction perpendicular to the filter) were measured. Next, in the measurement of the wavelength shift, the reference of the azimuthal angle was set to an angle that bisects the intersection angle between the in-plane slow axis of the first liquid crystal layer and the in-plane slow axis of the second liquid crystal layer, and an average value of the wavelength shift values in a case where light was incident from a polar angle of 60° in the directions of the azimuthal angles of 0° and 90° was determined. In addition, the side lobe value was determined as an average value of proportions of the transmittance at the wavelength of the side lobe on both sides to the transmittance at the peak wavelength.

The results are shown in Table 2 below.

TABLE 2

| Vertical incidence | | Oblique incidence | |
|---|---|---|---|
| Central wavelength | Half-width | Wavelength shift value | |
| nm | nm | nm | Side lobe value |
| 550 | 120 | 90 | 10% |

### Example 1

Eight horizontally aligned liquid crystal layers were manufactured using the same method as in Comparative Example 1.

### (Formation of Vertically Aligned Liquid Crystal Layer Using Rod-Like Liquid Crystal Compound)

Next, in order to manufacture a vertically aligned liquid crystal layer using a rod-like liquid crystal compound, a composition E-1 was prepared as follows.

Composition E-1

| | | |
|---|---|---|
| The rod-like liquid crystal compound L-1 | 100.00 | parts by mass |
| Polymerizable monomer (M-4) shown below | 8 | parts by mass |
| Polymerization initiator (Irgacure 127, | 2 | parts by mass |
| manufactured by BASF SE) | | |
| Polymerization initiator (Irgacure OXE01, | 4 | parts by mass |
| manufactured by BASF SE) | | |
| Fluorine-based polymer (M-5) | 0.4 | parts by mass |
| Fluorine-based polymer (M-6) | 0.3 | parts by mass |
| Onium compound S01 | 2 | parts by mass |
| Polymer compound A107 | 5 | parts by mass |
| Toluene | 621 | parts by mass |
| Methyl ethyl ketone | 69 | parts by mass |

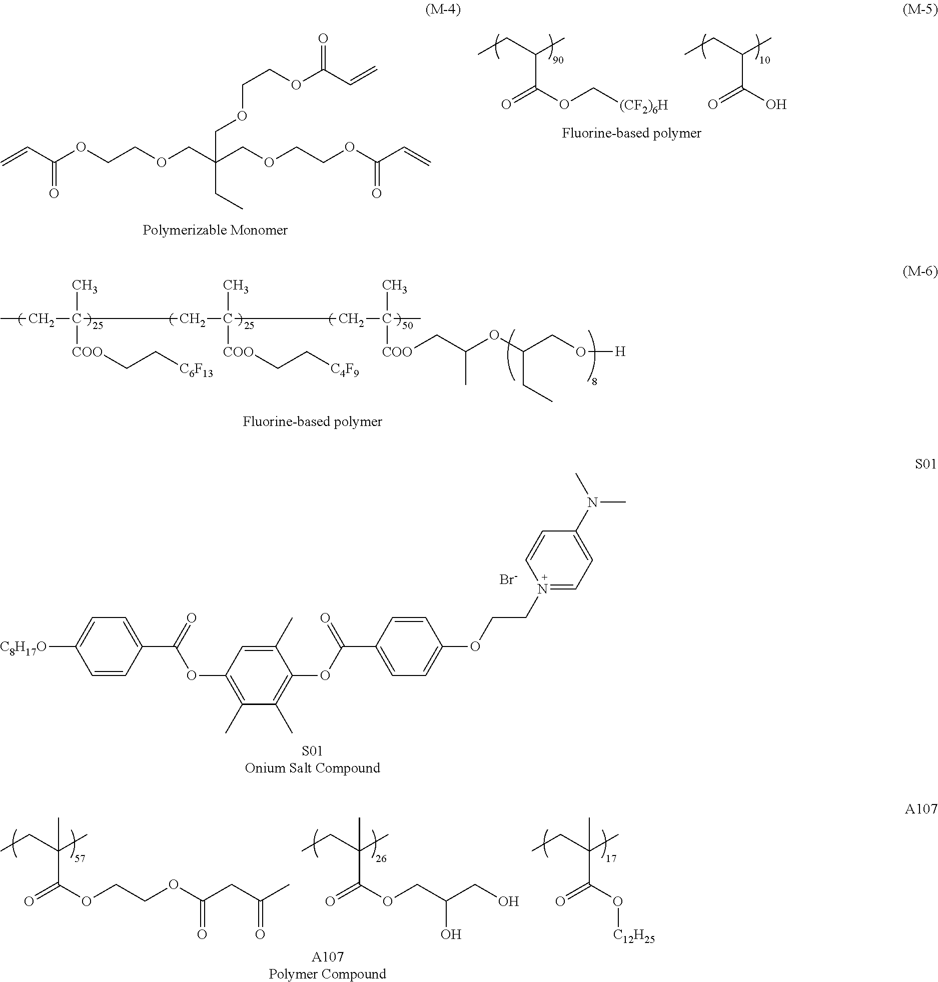

The composition E-1 was applied onto a support and then irradiated with ultraviolet rays (300 mJ/cm²) at 40° C. and an oxygen concentration of 100 ppm under a nitrogen purge to form an aligned immobilized layer (thickness: 0.86 μm) of a liquid crystal compound. Thereafter, the liquid crystal layer was peeled off from the support to obtain a vertically aligned liquid crystal layer.

It was confirmed that the optical characteristics of the vertically aligned liquid crystal layer were the characteristics shown in Table 3 below. Furthermore, in Table 3, Rth represents a thickness-direction retardation.

Eight such vertically aligned liquid crystal layers were manufactured.

TABLE 3

| Thickness d | | Rth |
|---|---|---|
| μm | Birefringence Δn | nm |
| 0.86 | 0.16 | 137.5 |

The manufactured vertically aligned liquid crystal layer was bonded to a horizontally aligned liquid crystal layer using a pressure sensitive adhesive (SK Dyne 2057, manufactured by Soken Chemical & Engineering Co., Ltd.) to manufacture eight liquid crystal layers (first liquid crystal layers and second liquid crystal layers).

The sum of the in-plane retardations of the horizontally aligned liquid crystal layer of the manufactured liquid crystal layer is 2 times the sum of the thickness-direction retardations of the vertically aligned liquid crystal layer.

The two liquid crystal layers were bonded using a pressure sensitive adhesive (manufactured by Soken Chemical & Engineering Co., Ltd., SK Dyne 2057) such that the angle formed between the in-plane slow axes of the two liquid crystal layers (the in-plane slow axes of the horizontally aligned liquid crystal layers) was 11.25°, that is, the angles with respect to the bisector of the angle formed between the in-plane slow axes were +5.625° and −5.625°, respectively, to manufacture a liquid crystal layer set. Four liquid crystal layer sets were formed in the same manner.

The four liquid crystal layer sets were bonded to each other using a pressure sensitive adhesive (SK Dyne 2057, manufactured by Soken Chemical & Engineering Co., Ltd.) to manufacture a liquid crystal polarization interference element. In this case, the liquid crystal layers were laminated such that the bisector of the angle formed between the in-plane slow axes in each of the liquid crystal layer sets was parallel to the bisector of the angle formed between the in-plane slow axes in each of the liquid crystal layer sets.

A filter was manufactured by laminating two polarizers arranged in a crossed nicols state to sandwich the manufactured liquid crystal polarization interference element. In this case, the liquid crystal layers were laminated such that the transmission axis of one polarizer and the bisector of an angle formed between the in-plane slow axes in each liquid crystal layer set were parallel to each other.

### Evaluation

For the manufactured filter, a wavelength shift value and a side lobe value were measured using a spectroradiometer “SR-3” manufactured by Topcon Technohouse Corporation in the same manner as described above.

The results are shown in Table 4 below.

TABLE 4

| Vertical incidence | | Oblique incidence | |
|---|---|---|---|
| Central wavelength | Half-width | Wavelength shift value | |
| nm | nm | nm | Side lobe value |
| 550 | 120 | Less than 5 | 10% |

### Example 2

A liquid crystal polarization interference element was manufactured and a filter was manufactured in the same manner as in Example 1, except that the optical characteristics of the vertically aligned liquid crystal layer were changed to the characteristics shown in Table 5 below in Example 1. In this case, the sum of the in-plane retardations of the horizontally aligned liquid crystal layer of the manufactured liquid crystal layer is 1.4 times the sum of the thickness-direction retardations of the vertically aligned liquid crystal layer.

TABLE 5

| Thickness d | | Rth |
|---|---|---|
| μm | Birefringence Δn | nm |
| 1.23 | 0.16 | 196 |

### Evaluation

For the manufactured filter, a wavelength shift value and a side lobe value were measured using a spectroradiometer “SR-3” manufactured by Topcon Technohouse Corporation in the same manner as described above.

The results are shown in Table 6 below.

TABLE 6

| Vertical incidence | | Oblique incidence | |
|---|---|---|---|
| Central wavelength | Half-width | Wavelength shift value | |
| nm | nm | nm | Side lobe value |
| 550 | 120 | 25 | 10% |

### Example 3

A liquid crystal polarization interference element was manufactured and a filter was manufactured in the same manner as in Example 1, except that the optical characteristics of the vertically aligned liquid crystal layer were changed to the characteristics shown in Table 7 below in Example 1. In this case, the sum of the in-plane retardations of the horizontally aligned liquid crystal layer of the manufactured liquid crystal layer is 3.1 times the sum of the thickness-direction retardations of the vertically aligned liquid crystal layer.

TABLE 7

| Thickness d | | Rth |
|---|---|---|
| μm | Birefringence Δn | nm |
| 0.55 | 0.16 | 88.7 |

### Evaluation

For the manufactured filter, a wavelength shift value and a side lobe value were measured using a spectroradiometer “SR-3” manufactured by Topcon Technohouse Corporation in the same manner as described above.

The results are shown in Table 8 below.

TABLE 8

| | |
|---|---|
| Vertical incidence | Oblique incidence |

| Central | Half-width | Wavelength | Side lobe |
|---|---|---|---|
| wavelength nm | nm | shift value nm | value |
| 550 | 110 | 18 | 10% |

### Example 4

### (Formation of Horizontally Aligned Liquid Crystal Layer Using Disk-Like Liquid Crystal Compound)

A composition D-1 consisting of disk-like compounds was prepared as follows.

Composition D-1

| | |
|---|---|
| Disk-like liquid crystal compound L-2 | 80.00 parts |
| | by mass |
| Disk-like liquid crystal compound L-3 | 20.00 parts |
| | by mass |
| Polymerization initiator (Irgacure (registered | 5.00 parts |
| trade name) 907, manufactured by BASF SE) | by mass |
| MEGAFACE F444 (manufactured by DIC Corporation) | 0.50 parts |
| | by mass |
| Methyl ethyl ketone | 300.00 parts |
| | by mass |

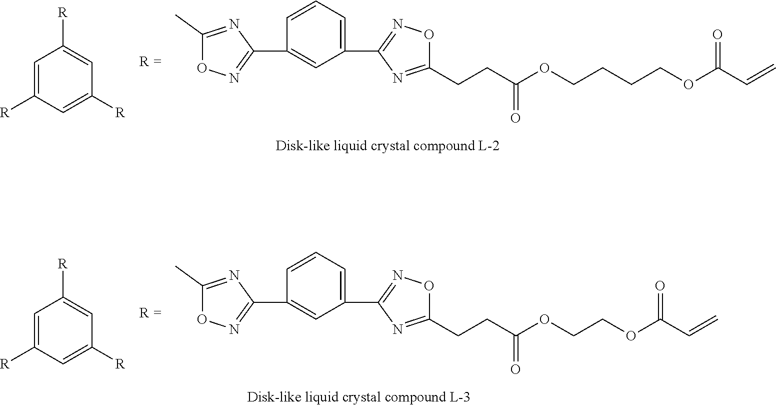

The composition D-1 was applied onto the alignment film P-2, heated, and then cured with ultraviolet rays to manufacture an immobilized layer (thickness: 1.72 μm) including disk-like liquid crystal compounds. Thereafter, the liquid crystal layer was peeled off from the photo alignment film to obtain a horizontally aligned liquid crystal layer in which the optical axes of the disk-like liquid crystal compounds were horizontally aligned.

It was confirmed that the optical characteristics of the horizontally aligned liquid crystal layer manufactured using the disk-like liquid crystal compounds were the characteristics shown in Table 9 below.

TABLE 9

| Thickness d μm | Birefringence Δn | Re nm |
|---|---|---|
| 1.72 | 0.16 | 275 |

### (Formation of Vertically Aligned Liquid Crystal Layer Using Disk-Like Liquid Crystal Compound)

Next, a vertically aligned liquid crystal layer in which the optical axes of the disk-like liquid crystal compounds were vertically aligned was manufactured. First, the coating liquid for forming an alignment film of Comparative Example 1 was changed as follows for the vertically aligned liquid crystal layer.

Coating liquid for forming alignment film

| | | |
|---|---|---|
| Modified polyvinyl alcohol below | 10 | parts by mass |
| Water | 371 | parts by mass |
| Methanol | 119 | parts by mass |
| Glutaraldehyde | 0.5 | parts by mass |
| Compound B shown below | 0.2 | parts by mass |

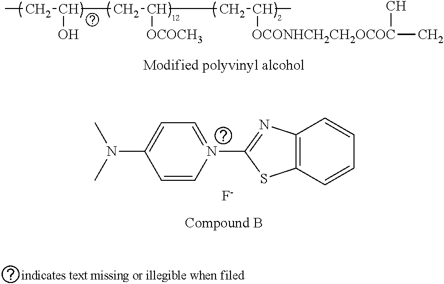

This coating liquid for forming an alignment film was applied onto a support by spin coating. Thereafter, the coating film was dried on a hot plate at 60° C. for 60 seconds to form an alignment film P-3.

The following liquid crystal composition was applied onto the alignment film P-3.

Composition D-2

| | |
|---|---|
| Disk-like liquid crystal compound L-2 | 80.00 parts |
| | by mass |
| Disk-like liquid crystal compound L-3 | 20.00 parts |
| | by mass |
| Ethylene oxide-modified trimethylolpropane | 9 parts |
| triacrylate (V#360, manufactured by | by mass |
| Osaka Organic Chemical Industry, Ltd.) | |
| Photopolymerization initiator (Irgacure 907, | 3 parts |
| manufactured by BASF SE) | by mass |
| Sensitizer (KAYACURE DETX, manufactured by | 1 part |
| Nippon Kayaku Co., Ltd.) | by mass |
| Methyl ethyl ketone | 195 parts |
| | by mass |

The composition D-2 was applied onto the alignment film and then irradiated with ultraviolet rays to form an aligned immobilized layer (thickness: 0.86 μm) with vertically aligned disk-like liquid crystal compounds. Thereafter, the liquid crystal layer was peeled off from the support to obtain a vertically aligned liquid crystal layer.

It was confirmed that the optical characteristics of the vertically aligned liquid crystal layer manufactured using the disk-like liquid crystal compounds were the characteristics shown in Table 10 below.

TABLE 10

| Thickness d μm | Birefringence Δn | Rth nm |
|---|---|---|
| 0.86 | 0.16 | −137.5 |

The manufactured vertically aligned liquid crystal layer was bonded to a horizontally aligned liquid crystal layer using a pressure sensitive adhesive (SK Dyne 2057, manufactured by Soken Chemical & Engineering Co., Ltd.) to manufacture a liquid crystal layer. Eight such liquid crystal layers were manufactured.

The absolute value of a sum of the in-plane retardations of the horizontally aligned liquid crystal layer of the manufactured liquid crystal layer is 2 times the absolute value of a sum of the thickness-direction retardations of the vertically aligned liquid crystal layer.

Using the manufactured liquid crystal layer as the first liquid crystal layer and the second liquid crystal layer, the two liquid crystal layers were bonded using a pressure sensitive adhesive (SK Dyne 2057, manufactured by Soken Chemical & Engineering Co., Ltd.) such that the angle formed between the in-plane slow axes of the two liquid crystal layers (the in-plane slow axes of the horizontally aligned liquid crystal layers) was 11.25°, that is, the angles with respect to the bisector of the angle formed between the in-plane slow axes were +5.625° and −5.625°, respectively, to manufacture a liquid crystal layer set. Four liquid crystal layer sets were formed in the same manner.

The four liquid crystal layer sets were bonded to each other using a pressure sensitive adhesive (SK Dyne 2057, manufactured by Soken Chemical & Engineering Co., Ltd.) to manufacture a liquid crystal polarization interference element. In this case, the liquid crystal layers were laminated such that the bisector of the angle formed between the in-plane slow axes in each of the liquid crystal layer sets was parallel to the bisector of the angle formed between the in-plane slow axes in each of the liquid crystal layer sets.

A filter was manufactured by laminating two polarizers arranged in a crossed nicols state to sandwich the manufactured liquid crystal polarization interference element. In this case, the liquid crystal layers were laminated such that the transmission axis of one polarizer and the bisector of an angle formed between the in-plane slow axes in each liquid crystal layer set were parallel to each other.

### Evaluation

For the manufactured filter, a wavelength shift value and a side lobe value were measured using a spectroradiometer “SR-3” manufactured by Topcon Technohouse Corporation in the same manner as described above.

The results are shown in Table 11 below.

TABLE 11

| | |
|---|---|
| Vertical incidence | Oblique incidence |

| Central | Half- | Wavelength | Side lobe |
|---|---|---|---|
| wavelength nm | width nm | shift value nm | value |
| 550 | 120 | Less than 5 | 10% |

### Example 5

A liquid crystal polarization interference element was manufactured using the same method as in Example 1, except that the thickness of the horizontally aligned liquid crystal layer was appropriately changed to set the in-plane retardation Re to a value shown in Table 12 below, the thickness of the vertically aligned liquid crystal layer was appropriately changed to set the thickness-direction retardation Rth to a value shown in Table 12 below, and the angle of the in-plane slow axis of each liquid crystal layer was set to a value shown in Table 12 below in Example 1.

TABLE 12

| Liquid | | Horizontally | Vertically | |
|---|---|---|---|---|
| crystal | Liquid | aligned liquid | aligned liquid | Angle of |
| layer | crystal | crystal layer | crystal layer | in-plane |
| set | layer | Re nm | Rth nm | slow axis ° |
| First | First | 291 | 145.5 | 1.8 |
| | Second | 291 | 145.5 | −1.8 |
| Second | First | 267 | 133.5 | 9.4 |
| | Second | 267 | 133.5 | −9.4 |
| Third | First | 267 | 133.5 | 9.4 |
| | Second | 267 | 133.5 | −9.4 |
| Fourth | First | 291 | 145.5 | 1.8 |
| | Second | 291 | 145.5 | −1.8 |

Using this liquid crystal polarization interference element, a filter was manufactured in the same manner as in Example 1, and a wavelength shift value and a side lobe value were measured in the same manner as in Example 1.

The results are shown in Table 13 below.

TABLE 13

| | |
|---|---|
| Vertical incidence | Oblique incidence |

| Central | Half- | Wavelength | Side lobe |
|---|---|---|---|
| wavelength nm | width nm | shift value nm | value |
| 550 | 120 | Less than 5 | 3% or less |

From the results above, it can be seen that Examples of the present invention have a smaller wavelength shift value than that in Comparative Examples.

Moreover, from the comparison of Examples 1 to 3, it can be seen that the sum of the in-plane retardations of the horizontally aligned liquid crystal layer is preferably close to about 2 times the sum of the thickness-direction retardations of the vertically aligned liquid crystal layers.

In addition, from the comparison between Example 1 and Example 5, it can be seen that by reducing the in-plane retardation value of the liquid crystal layer of the liquid crystal layer sets on both sides in the thickness direction and increasing the absolute value of the slow axis θ of the liquid crystal layer, the side lobe of the band-pass filter can be reduced.

### Example 6

In order to evaluate the optical performance of the laminate of the birefringent medium, the liquid crystal polarization interference element in which the infrared absorbing colorant was added to the liquid crystal layer was modeled and the filter was modeled in Example 5 by optical simulation (Optical Waves in Layered Media 2nd Edition, Pochi Yeh, Wiley-Interscience (Mar. 3, 2005)). Furthermore, the infrared absorbing colorant was required to have dichroic absorption in the near infrared region and to be aligned as a guest colorant in a liquid crystal compound serving as a host.

The central wavelength, the half-width, the wavelength shift value, and the side lobe value were calculated by simulation. In addition, in a case where a ratio of the birefringence Δn (450) at a wavelength of 450 nm to the birefringence Δn (650) at a wavelength of 650 nm was calculated, Δn (450)/Δn (650) was 1.4. In a case where Δn (450)/Δn (650) exceeds 1.3, it can be said that the dispersion is strong normal dispersion.

The results are shown in Table 14 below.

TABLE 14

| | |
|---|---|
| Vertical incidence | Oblique incidence |

| Central | Half- | Wavelength | Side lobe |
|---|---|---|---|
| wavelength nm | width nm | shift value nm | value |
| 550 | 60 | Less than 5 | 3% or less |

As described above, in the band-pass filter of Example 5, the central wavelength of transmitted light was 550 nm and the half-width of the transmitted light was 120 nm. In contrast, in Example 6 in which the infrared absorbing colorant was added to the liquid crystal layer, it can be seen that a band-pass filter having a narrower wavelength range of transmitted light can be obtained by narrowing the half-width of transmitted light.

### Example 7

By the above-described simulation, in Example 5, a filter was manufactured in the same manner as in Example 5, using a liquid crystal elastomer as the liquid crystal compound forming the liquid crystal layer. Furthermore, the liquid crystal elastomer was a liquid crystal elastomer prepared using a liquid crystal monomer, a crosslinking agent, and a plasticizer, described in JP2020-131638A.

The liquid crystal polarization interference element of the manufactured filter was able to be stretched by a uniaxial and biaxial stretching device, and the central wavelength was calculated by performing stretching of 10% and 20%.

The results are shown in Table 15 below.

TABLE 15

| | | | | Central | Central |
|---|---|---|---|---|---|
| Vertical incidence | | Oblique incidence | | wavelength | wavelength |
| Central | Half- | Wavelength | Side | after 10% | after 20% |
| wavelength | width | shift value | lobe | stretching | stretching |
| nm | nm | nm | value | nm | nm |
| 550 | 120 | Less than 5 | 3% or | 525 | 500 |
| | | | less | | |

From the results above, it can be seen that by using the liquid crystal elastomer in the liquid crystal layer, the wavelength range can be made variable by stretching and contracting the liquid crystal layer, that is, the filter.

### Example 7

In contrast in Example 1 in which eight liquid crystal layers (the first liquid crystal layers and the second liquid crystal layers) were manufactured to form four liquid crystal layer sets, twelve liquid crystal layers (the first liquid crystal layers and the second liquid crystal layers) were manufactured to form six liquid crystal layer sets. The two liquid crystal layers were bonded using a pressure sensitive adhesive (manufactured by Soken Chemical & Engineering Co., Ltd., SK Dyne 2057) such that the angle formed between the in-plane slow axes of the two liquid crystal layers (the in-plane slow axes of the horizontally aligned liquid crystal layers) was 7.5°, that is, the angles with respect to the bisector of the angle formed between the in-plane slow axes were +3.75° and −3.75°, respectively, to manufacture a liquid crystal layer set. A filter was manufactured in the same manner as in Example 1, except for the above, and the wavelength shift value and the side lobe value were measured. The results are shown in Table 16 below.

TABLE 16

| | |
|---|---|
| Vertical incidence | Oblique incidence |

| Central | Half- | Wavelength | Side lobe |
|---|---|---|---|
| wavelength nm | width nm | shift value nm | value |
| 550 | 80 | Less than 5 | 10% |

From the results of Example 7, it can be seen that even in a case where the total number of liquid crystal layers is different, the wavelength shift value is smaller than that in Comparative Examples.

### Example 8

In Example 1, a retardation layer was arranged between one polarizer of the polarizers arranged in a crossed nicols state and the liquid crystal polarization interference element. The retardation layer brings about an effect of maintaining the orthogonal relationship of the polarization directions by the linear polarizers arranged in a crossed nicols state not only in the front but also in an oblique direction. A positive C-plate (having a thickness-direction retardation Rth of −90 nm) in which a rod-like liquid crystal compound was vertically aligned and a positive A-plate (having an in-plane-direction retardation Re of 140 nm) in which a rod-like liquid crystal compound was horizontally aligned were arranged and bonded in this order adjacent to the first polarizer. In this case, the in-plane slow axis of the positive A plate was installed in parallel with the absorption axis of the polarizer on one side. In this manner, a filter was manufactured, and the wavelength shift value and the side lobe value were measured in the same manner as in Example 1. The results are shown in Table 17 below.

TABLE 17

| | |
|---|---|
| Vertical incidence | Oblique incidence |

| Central | Half- | Wavelength | Side lobe |
|---|---|---|---|
| wavelength nm | width nm | shift value nm | value |
| 550 | 120 | Less than 3 | 10% |

From the results of Example 8, it can be seen that the wavelength shift value was smaller than that in Comparative Examples even in the configuration in which the retardation layer was arranged between the polarizer and the liquid crystal polarization interference element. In addition, from the comparison with Example 1, it can be seen that the wavelength shift value upon oblique incidence can be further reduced by arranging the retardation layer.

### Example 9

In Example 1, a liquid crystal polarization interference element was manufactured by arranging eight liquid crystal layers such that the angles of the in-plane slow axes had the relationship shown in Table 18, and a filter was manufactured by changing the arrangement of the polarizer from a crossed nicols state to a parallel nicols state. The arrangement of the liquid crystal layers in Example 9 corresponds to a band-pass filter in which a Solc filter (Fan Solc filter) is arranged between polarizers arranged in a parallel nicols state, the Solc filter being formed by laminating birefringent plates (λ/2 retardation plates) having the same thickness and having angles formed between the direction of the transmission axis of the polarizer and the slow axis of ρ, 3ρ, 5ρ, . . .

TABLE 18

| Liquid crystal | Liquid crystal | Angle of in-plane |
|---|---|---|
| layer set | layer | slow axis |
| First | First | 5.625 |
| | Second | 16.875 |
| Second | First | 28.125 |
| | Second | 39.375 |
| Third | First | 50.625 |
| | Second | 61.875 |
| Fourth | First | 73.125 |
| | Second | 84.375 |

For the manufactured filter, the wavelength shift value and the side lobe value were measured in the same manner as in Example 1. The results are shown in Table 19 below.

TABLE 19

| | |
|---|---|
| Vertical incidence | Oblique incidence |

| Central | Half- | Wavelength | Side lobe |
|---|---|---|---|
| wavelength nm | width nm | shift value nm | value |
| 550 | 120 | Less than 5 | 10% |

From the results of Example 9, it can be seen that the wavelength shift value was smaller than that in Comparative Examples even in the configuration in which each liquid crystal layer was arranged such that the angle formed between the direction of the transmission axis of the polarizer and the direction of the slow axis was ρ, 3ρ, 5ρ, . . . .

From the results above, the effects of the present invention are apparent.

The optical filter of the embodiment of the present invention can be suitably used as a band-pass filter and the like in various optical devices.

### EXPLANATION OF REFERENCES

10, 10b: filter
12: first polarizer
14: second polarizer
16, 16b: liquid crystal polarization interference element
18: rod-like liquid crystal compound
18ₕ₁ₐ, 18ₕ₁ₙ: first-1 rod-like liquid crystal compound
18ᵥ₁ₐ, 18ᵥ₁ₙ: first-2 rod-like liquid crystal compound
18ₕ₂ₐ, 18ₕ₂ₙ: second-1 rod-like liquid crystal compound
18ᵥ₂ₐ, 18ᵥ₂ₙ: second-2 rod-like liquid crystal compound
19: disk-like liquid crystal compound
19ₕ₁ₐ, 19ₕ₁ₙ: first-1 disk-like liquid crystal compound
19ᵥ₁ₐ, 19ᵥ₁ₙ: first-2 disk-like liquid crystal compound
19ₕ₂ₐ, 19ₕ₂ₙ: second-1 disk-like liquid crystal compound
19ᵥ₂ₐ, 19ᵥ₂ₙ: second-2 disk-like liquid crystal compound
20, 20a, 20n, 21, 21a, 21n: first liquid crystal layer
20H, 20Ha, 20Hn, 21H, 21Ha, 21Hn: first horizontally aligned liquid crystal layer
20V, 20Va, 20Vn, 21V, 21Va, 21Vn: first vertically aligned liquid crystal layer
24, 24a, 24n, 25, 25a, 25n: second liquid crystal layer
24H, 24Ha, 24Hn, 25H, 25Ha, 25Hn: second horizontally aligned liquid crystal layer
24V, 24Va, 24Vn, 25V, 25Va, 25Vn: second vertically aligned liquid crystal layer
26, 27: liquid crystal layer set
26a, 27a: first liquid crystal layer set
26n, 27n: n-th liquid crystal layer set

What is claimed is:

1. A liquid crystal polarization interference element comprising:
two or more liquid crystal layer sets in a thickness direction, each set consisting of a first liquid crystal layer and a second liquid crystal layer,
wherein the first liquid crystal layer includes at least one first horizontally aligned liquid crystal layer formed by immobilizing first-1 liquid crystal compounds having optical axes aligned horizontally, and at least one first vertically aligned liquid crystal layer formed by immobilizing first-2 liquid crystal compounds having optical axes aligned vertically,
the second liquid crystal layer includes at least one second horizontally aligned liquid crystal layer formed by immobilizing second-1 liquid crystal compounds having optical axes aligned horizontally, and at least one second vertically aligned liquid crystal layer formed by immobilizing second-2 liquid crystal compounds having optical axes aligned vertically,
any of the first-1 liquid crystal compounds and the first-2 liquid crystal compounds are rod-like liquid crystal compounds or disk-like liquid crystal compounds,
any of the second-1 liquid crystal compounds and the second-2 liquid crystal compounds are rod-like liquid crystal compounds or disk-like liquid crystal compounds,
an in-plane slow axis of the first liquid crystal layer and an in-plane slow axis of the second liquid crystal layer intersect with each other,
a sum of in-plane retardations of the first horizontally aligned liquid crystal layer is 1.33 to 4 times a sum of thickness-direction retardations of the first vertically aligned liquid crystal layer,
a sum of in-plane retardations of the second horizontally aligned liquid crystal layer is 1.33 to 4 times a sum of thickness-direction retardations of the second vertically aligned liquid crystal layer, and
an in-plane retardation of the first liquid crystal layer and an in-plane retardation of the second liquid crystal layer are equal to each other.

2. The liquid crystal polarization interference element according to claim 1,
wherein the sum of the in-plane retardations of the first horizontally aligned liquid crystal layer is 2 times the sum of the thickness-direction retardations of the first vertically aligned liquid crystal layer, and
the sum of the in-plane retardations of the second horizontally aligned liquid crystal layer is 2 times the sum of the thickness-direction retardations of the second vertically aligned liquid crystal layer.

3. The liquid crystal polarization interference element according to claim 1,
wherein the liquid crystal polarization interference element has three or more liquid crystal layer sets in the thickness direction, and
the angles formed between the in-plane slow axis of the first liquid crystal layer and the in-plane slow axis of the second liquid crystal layer, and in-plane retardations of the first liquid crystal layer and the second liquid crystal layer differ between the liquid crystal layer sets arranged on both sides in the thickness direction and the liquid crystal layer set arranged in a central part in the thickness direction.

4. The liquid crystal polarization interference element according to claim 1,
wherein the first liquid crystal layer and the second liquid crystal layer include an infrared absorbing colorant.

5. The liquid crystal polarization interference element according to claim 1,
wherein the first liquid crystal layer and the second liquid crystal layer include a liquid crystal elastomer.

6. A filter comprising:
the liquid crystal polarization interference element according to claim 1; and
two polarizers that sandwich the liquid crystal polarization interference element in a thickness direction,
wherein the two polarizers are arranged such that transmission axes of the two polarizers are orthogonal to each other.

7. The filter according to claim 6, further comprising:
a retardation layer between one or both of the two polarizers and the liquid crystal layer set,
wherein an in-plane slow axis of the retardation layer is parallel to an absorption axis of either of both the polarizers.

8. The liquid crystal polarization interference element according to claim 2,
wherein the liquid crystal polarization interference element has three or more liquid crystal layer sets in the thickness direction, and
the angles formed between the in-plane slow axis of the first liquid crystal layer and the in-plane slow axis of the second liquid crystal layer, and in-plane retardations of the first liquid crystal layer and the second liquid crystal layer differ between the liquid crystal layer sets arranged on both sides in the thickness direction and the liquid crystal layer set arranged in a central part in the thickness direction.

9. The liquid crystal polarization interference element according to claim 2,
wherein the first liquid crystal layer and the second liquid crystal layer include an infrared absorbing colorant.

10. The liquid crystal polarization interference element according to claim 2,
wherein the first liquid crystal layer and the second liquid crystal layer include a liquid crystal elastomer.

11. A filter comprising:
the liquid crystal polarization interference element according to claim 2; and
two polarizers that sandwich the liquid crystal polarization interference element in a thickness direction,
wherein the two polarizers are arranged such that transmission axes of the two polarizers are orthogonal to each other.

12. The filter according to claim 11, further comprising:
a retardation layer between one or both of the two polarizers and the liquid crystal layer set,
wherein an in-plane slow axis of the retardation layer is parallel to an absorption axis of either of both the polarizers.

13. The liquid crystal polarization interference element according to claim 3,
wherein the first liquid crystal layer and the second liquid crystal layer include an infrared absorbing colorant.

14. The liquid crystal polarization interference element according to claim 3,
wherein the first liquid crystal layer and the second liquid crystal layer include a liquid crystal elastomer.

15. A filter comprising:
the liquid crystal polarization interference element according to claim 3; and
two polarizers that sandwich the liquid crystal polarization interference element in a thickness direction,
wherein the two polarizers are arranged such that transmission axes of the two polarizers are orthogonal to each other.

16. The filter according to claim 15, further comprising:
a retardation layer between one or both of the two polarizers and the liquid crystal layer set,
wherein an in-plane slow axis of the retardation layer is parallel to an absorption axis of either of both the polarizers.

17. The liquid crystal polarization interference element according to claim 4,
wherein the first liquid crystal layer and the second liquid crystal layer include a liquid crystal elastomer.

18. A filter comprising:
the liquid crystal polarization interference element according to claim 4; and
two polarizers that sandwich the liquid crystal polarization interference element in a thickness direction,
wherein the two polarizers are arranged such that transmission axes of the two polarizers are orthogonal to each other.

19. The filter according to claim 18, further comprising:
a retardation layer between one or both of the two polarizers and the liquid crystal layer set,
wherein an in-plane slow axis of the retardation layer is parallel to an absorption axis of either of both the polarizers.

20. A filter comprising:
the liquid crystal polarization interference element according to claim 5; and
two polarizers that sandwich the liquid crystal polarization interference element in a thickness direction,
wherein the two polarizers are arranged such that transmission axes of the two polarizers are orthogonal to each other.
